(19) United States
(12) Patent Application Publication
(10) Pub. No.: US 2026/0337069 A1
(43) Pub. Date: Oct. 29, 2026

(54) NEGATIVE EMISSIONS USING INORGANIC WASTE RECYCLING

(71) Applicant: X Development LLC, Mountain View, CA (US)

(72) Inventors: Shijian Jin, Cambridge, MA (US); Antonio Raymond Papania-Davis, Oakland, CA (US); Christopher Hunter Van Arsdale, Seattle, WA (US); Michael Dominik Mortenson Tyka, Seattle, WA (US)

(21) Appl. No.: 19/662,955

(22) Filed: Apr. 29, 2026

Related U.S. Application Data
(63) Continuation of application No. PCT/US2024/061920, filed on Dec. 26, 2024.
(60) Provisional application No. 63/615,171, filed on Dec. 27, 2023.
(60) Provisional application No. 63/678,784, filed on Aug. 2, 2024.

(51) Int. Cl. C02F 1/66; B01D 53/14; B01D 61/42; B01D 61/44; C02F 1/469; C02F 103/08; C04B 18/10; C04B 18/167; C04B 20/02

(52) U.S. Cl. CPC C02F 1/66; B01D 53/1475; B01D 53/1493; B01D 61/422; B01D 61/445; C02F 1/4693; C04B 18/105; C04B 18/167; C04B 20/023; B01D 2252/1035; B01D 2257/504; B01D 2258/06; C02F 2103/08

(57) ABSTRACT

Provided herein are methods and systems for achieving ocean alkalinity enhancement (OAE), which provides a means of reducing atmospheric carbon dioxide levels, through electrolytic salt splitting. Treatment of ocean waters with the alkaline portion of salt splitting and treatment of inorganic waste with the acid portion of the salt splitting provide a means of achieving OAE without adding mineral content from land while at the same time providing a means of recycling inorganic waste in the form of recycled concrete aggregates.

### CROSS-REFERENCE TO RELATED APPLICATIONS

This application continuation of International Application No. PCT/US24/61920, filed Dec. 26, 2024, which claims the benefit of priority to U.S. Application No. 63/615,171, filed on Dec. 27, 2023, and U.S. Application No. 63/678,784, filed on Aug. 2, 2024, the contents of which are hereby incorporated by reference in their entirety including any drawings.

### TECHNICAL FIELD

The present disclosure relates to methods for ocean alkalinity enhancement to reduce carbon dioxide emissions via application of byproducts from inorganic waste treatment.

### BACKGROUND

The Intergovernmental Panel on Climate Change (IPCC) calls for active CO₂ removal (CDR) to offset emissions. Ocean alkalinity enhancement (OAE) represents a potential method for carbon dioxide removal (CDR) at large scale. Increased alkalinity of water increases its ability to store CO₂ as bicarbonate ions (HCO₃⁻). To this end, a source of alkalinity on significant scale is required. Ideally, OAE is accomplished adding no mineral content from land.

### SUMMARY

Provided herein are methods and systems for achieving ocean alkalinity enhancement by way of salt splitting by electrolysis or electrodialysis, with treatment of ocean waters with the alkaline portion of salt splitting and treatment of inorganic waste with the acid portion of the salt splitting. The systems and methods described herein offer a means of providing a source of alkalinity for OAE without adding mineral content from land while at the same time providing a means of recycling inorganic waste.

Some embodiments provide a method of increasing the pH of a body of saline water comprising:
(a) contacting saline water obtained from the body of saline water with an electrolyzer to obtain a liquid rich in one or more metal hydroxide and a liquid rich in HCl;
(b) contacting the body of saline water with the liquid rich in one or more metal hydroxide of step (a);
(c) contacting inorganic waste with the liquid rich in HCl of step (a) to form recovered concrete aggregates and a liquid rich in inorganic salts; and
(d) optionally repeating steps (a)-(c).

Another embodiment provides a system configured to perform the method described herein.

Some embodiments provide a system comprising:
a drum configured to house coarse inorganic waste;
a motor configured to agitate the drum;
a pump in fluid communication with (a) the drum and (b) a tank configured to house a fluid;
a first set of sensors configured to generate first sensor data representing one or more qualities of the coarse inorganic waste in the drum;
a second set of sensors configured to generate second sensor data representing one or more qualities of the fluid in the tank;
a control system communicably coupled with the motor, the pump, the first set of sensors, and the second set of sensors and configured to perform operations comprising:
operating the pump to circulate the fluid between the tank and the drum;
operating the motor to agitate the drum;
determining, using at least one of the first sensor data and the second sensor data, that:
the one or more qualities of the coarse inorganic waste in the drum satisfy first criteria;
or
the one or more qualities of the fluid in the tank satisfy second criteria; and
operating the motor to cease agitating the drum.

In some embodiments, the system described herein comprises a mobile plant for processing inorganic waste, comprising:
a mobile platform; and
the system described herein mounted to the mobile platform.

### BRIEF DESCRIPTION OF DRAWINGS

FIGS. 1A and 1B show how electrochemical salt splitting is used to combine OAE with concrete waste treatment.

FIGS. 2A, 2B, and 2C show the appearance of recycled cement aggregates (RCA) after the first, second, and third portions of 0.5 M HCl, respectively, were added and each 6 h treatment period was completed. The extent of mortar shell on the aggregates can be seen to be reduced after each treatment period. The total treatment time for FIGS. 2A, 2B, and 2C was 6 h, 12 h, and 18 h, respectively.

FIG. 3 shows the solution pH during each treatment period of RCA with 0.5 M HCl (aq.). The pH was initially low after each portion of HCl was added, then gradually increased as the mortar shell material reacted with and neutralized the acid.

FIG. 4 shows the water absorption (WA) value of RCA before and after treatment with HCl.

FIG. 5 shows compression strength of concrete cylinders prepared with RCA (untreated) and RCA treated with acid.

FIG. 6A shows schematic of rotary drum reactor system used for treating RCA.

FIG. 6B shows a system for treating RCA.

FIG. 6C shows a block diagram of an example control system for a system for treating RCA.

FIG. 7 shows RCA treated by different methods: FIG. 7A shows RCA after agitating in a rotary drum filled with water for 96 hours; FIG. 7B shows RCA after reacting with 0.5 M HCl on an orbital shaker for 88 hours; and FIG. 7C shows RCA after reacting with 0.5 M HCl in a rotary drum for 24 hours.

FIG. 8 shows water absorption in RCA vs. treatment conditions.

FIG. 9 shows % reduction in water absorption in untreated RCA relative to RCA treated under different conditions.

FIGS. 10A, 10B, and 10C show the effect of RCA loading, reaction time and acid-to-RCA (AR) ratio on (A) the water absorption of the resulting aggregates, (B) post-reaction solution pH and (C) post-reaction solution conductivity, respectively.

FIG. 11 shows a photo of the solution after the rotary drum reaction and after further treatment with RCA fines.

FIGS. 12A and 12B show pH and conductivity, respectively, of the solution after the rotary drum reaction and after further treatment with RCA fines.

FIG. 13 shows elemental composition by inductively coupled plasma optical emission spectroscopy (ICP-OES) and ion chromatography (IC) of the solution after the rotary drum reaction and after further treatment with RCA fines.

FIG. 14A and FIG. 14B show the CO₂ content in two RCA samples with diameter 9.5-12.7 mm and 6.7-9.5 mm, and the CO₂ content in synthetic RCA samples after two years and two weeks of storage in air, respectively.

FIG. 15 shows phenaphtalein test on the synthetic RCA samples.

FIG. 16 shows phenaphtalein test on a RCA (left), a RCA cut in half (center), and a RCA tumbled in water for four days (right).

FIG. 17 shows estimated amount of CaO needed to neutralize waste acid generated by electrochemical OAE plants and the amount available from construction and demolition (C&D) waste in the same regions.

FIG. 18 shows example platforms for mobile processing plants.

### DETAILED DESCRIPTION

The Intergovernmental Panel on Climate Change (IPCC) emphasizes the necessity of active carbon dioxide removal (CDR) strategies to help mitigate global climate change. In this regard, specific sectors present substantial emission reduction challenges. The concrete industry exemplifies this, contributing an estimated 6-10% of global CO₂ emissions, with ~60% stemming from the calcination reaction inherent to cement production. Ocean alkalinity enhancement (OAE) has emerged as a promising technique for gigatonne-scale CDR. By introducing alkalinity or removing acidity from the ocean, OAE enhances its capacity to sequester CO₂ as (bi) carbonate ions as described herein. However, identifying an economically practical and sustainable source of alkalinity remains a challenge for OAE implementation.

Besides emitting a significant amount of CO₂ into air from increased cement production, the expansion of urban areas and growth of manufacturing and industrial sectors have led to a considerable accumulation of construction and demolition (C&D) waste. This waste is a significant source of alkalinity and a potential raw material for recycled concrete aggregates (RCA), a substitute for natural aggregates, which are becoming increasingly scarce due to growing global demand and mining. Although RCAs are usually landfilled or used in less demanding projects like sidewalks, road bases, and parking lots, their application in highly demanding construction projects like roads or bridges is limited. The high water absorption caused by the porous mortar shell, i.e. a hardened mixture of sand, cement and water, covering the aggregates results in lower strength, reduced durability, and other undesirable properties of concrete containing RCA. The volume of RCA becomes a burden for landfills, which have become increasingly costly. Therefore, finding a cost-effective way to convert RCA into high-quality aggregates offers not only a potential avenue for the mitigation of these disposal costs, but offers an environmentally responsible method of recycling high-quality aggregate.

Increased alkalinity of ocean water increases its ability to store CO₂ as bicarbonate ions (HCO₃⁻) via the following reaction:

HO⁻+CO₂→HCO₃⁻ (Eq.1)

Either addition of alkalinity or removal of acidity from the ocean increases the ability to sequester CO₂ according to Equation 1. Approaches that simply add alkaline materials to the ocean have the disadvantage of slow dissolution (e.g., National Academies of Sciences, Engineering, and Medicine. 2022. A Research Strategy for Ocean-based Carbon Dioxide Removal and Sequestration. Washington, DC: The National Academies Press) and introduce iron, silicates and heavy metals to the ocean which is undesirable [Front. Clim., 11 Oct. 2019, Sec. Carbon Dioxide Removal, Vol. 1-2019] and faces environmental opposition. The alternative approach is to remove acidity from the ocean (increasing pH), but the electrochemical process by which this can be achieved (as described in the literature) are relatively energy-, and therefore cost-intensive due to the significant need for electricity. Furthermore, while avoiding addition of any extraneous material to the ocean, it produces a stream of dilute hydrochloric acid that is to be disposed of. To reduce cost, a profitable valorization for this waste product is needed.

Electrochemical OAE efforts are currently focused on profitability via the sale of emissions credits, while the acid byproduct is considered a waste product that is neutralized with alkaline materials and disposed of. Ideally, the waste acid is neutralized with terrestrial alkaline materials, as the negative emissions effect of the concomitant alkalinity is negated, if the acid were to return to the ocean. It represents a challenge to sell the waste acid into markets that may use it to neutralize alkaline industrial wastes, as this may simply replace other acidity already being used, providing no additionality. Neutralization is ideally done with materials not otherwise slated for neutralization. Furthermore, the quantity of this dilute acid presents a significant roadblock to the growth of these CO₂ removal technologies, since the existing markets for dilute acids are relatively small. The concentration of the waste acid is generally low, around 0.5-1.0 M, resulting in a very large volume of liquid. Since active removal of water from this waste liquid would likely be uneconomical, a direct disposal and neutralization pathway is desired.

The present disclosure provides, inter alia, an integrated process that combines the two seemingly unrelated concepts of OAE and RCA remediation. The integrated process described herein enables (1) eliminating undesirable, low quality HCl generated from electrochemical OAE and (2) transforming RCA from waste concrete into reusable aggregates with low WA.

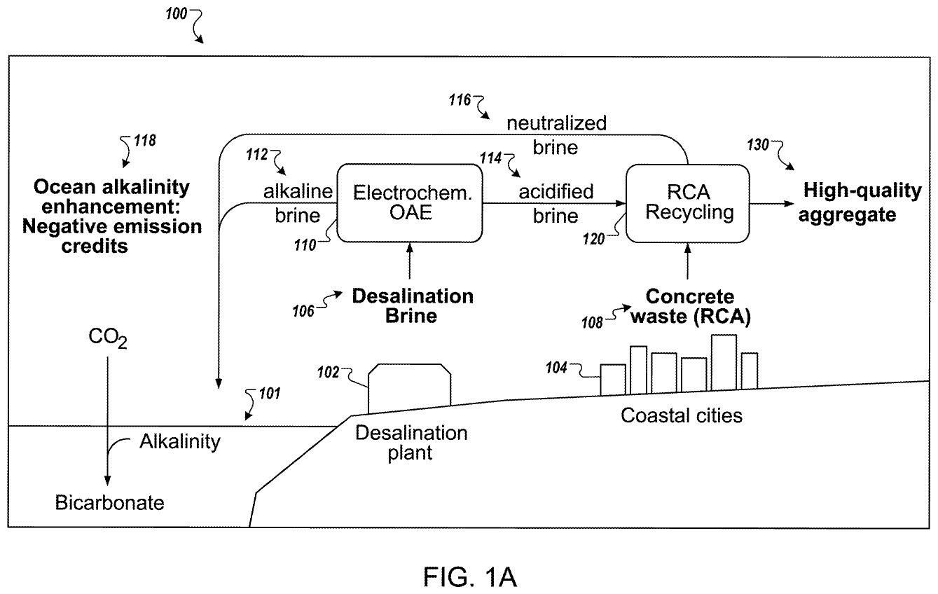

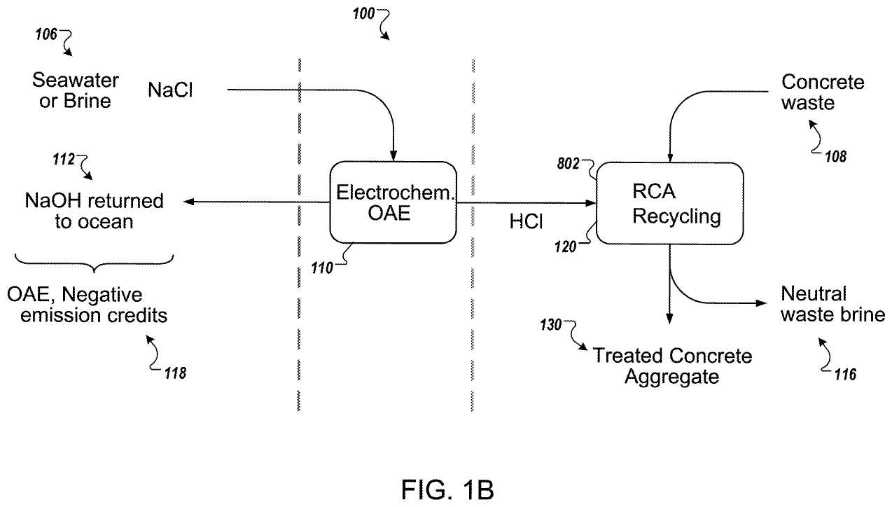

The present disclosure provides a combined process which generates negative emissions through electrochemical OAE (profitable via negative emissions credits, produces an acid waste product) coupled directly to the recycling of concrete aggregates (profitable via the sale of upcycled high-quality aggregates and the avoidance of tipping fee associated with landfill of large volume of waste). An overview of this process is shown in FIGS. 1A and 1B.

FIG. 1A shows an overview of a system 100 for combining OAE with concrete waste treatment. Coastal seawater or brine 106 from a desalination plant 102 is used to provide sodium chloride salt (NaCl) as a feedstock for an electrochemical process performed by an electrochemical OAE system 110. Brine is a solution of water and salt. The electrochemical OAE system 110 can include an electrolyzer. The electrochemical process can be an electrolytic salt splitting process that produces dilute alkaline materials such as alkaline brine 112 (e.g., NaOH or Mg(OH)₂). The electrolytic salt splitting process also produces dilute acidified materials such as acidified brine 114 (e.g., hydrochloric acid (HCl)). While the alkaline brine 112 returns to the ocean 101, the acidified brine 114 can be used in an RCA recycling process 120. The process 120 includes obtaining concrete waste, or RCA 108 from areas such as coastal cities 104. The process 120 includes removing residual mortar shell from the RCA in order to provide treated high quality aggregate 130 for concrete. During the process 120, the HCl is neutralized resulting in a stream of neutralized brine that can include chloride salts (e.g., NaCl or CaCl₂) which can safely be disposed of or used in other industries. The treated concrete aggregate 130 can be used by concrete manufacturers to be used once again in new concrete. FIG. 1B shows a simplified version of the system 100.

Advantageously, this process adds no material from land to the ocean, a critical distinction that helps to overcome environmental concerns about dissolution of foreign materials in the ocean. The output of alkaline brine 112 into the ocean 101 results in alkalinity enhancement and negative emissions. The negative emissions can result in carbon credit.

### DEFINITIONS

To facilitate understanding of the disclosure set forth herein, a number of additional terms are defined below. Generally, the nomenclature and procedures described herein are those well known and commonly employed in the art. Unless defined otherwise, all technical and scientific terms used herein generally have the same meaning as commonly understood by one of ordinary skill in the art to which this disclosure belongs. Each of the patents, applications, published applications, and other publications that are mentioned throughout the specification and the attached appendices are incorporated herein by reference in their entireties.

The term “about” when referring to a number or a numerical range means that the number or numerical range referred to is an approximation, for example, within experimental variability and/or statistical experimental error, and thus the number or numerical range may vary up to ±10% of the stated number or numerical range.

The term “electrochemical cell” as used here refers to devices and/or device components that perform electrochemistry. Electrochemical cells have two or more electrodes (e.g., a cathode and an anode) and one or more electrolytes.

The term “separator” as defined herein, refers to the material between the cathode and anode reservoirs in an electrochemical cell. Representative separators include, but are not limited to cation exchange membranes and anion exchange membranes.

The terms “liquid rich in” an ingredient(s) as provided throughout the disclosure is intended to mean that the liquid contains a concentration of at least 0.1 M of said ingredient(s). For example, the term “liquid rich in one or more metal hydroxide” refers to a liquid having a one or more metal hydroxide concentration of at least 0.1 M (e.g., 0.1 M to 5 M).

The term “inorganic salts” as used herein, refers to salts of alkali metals, alkali earth metals, transition metals and post-transition metals. Non-limiting examples of inorganic salts are NaCl, KCl, CaCl₂, FeCl₂, FeCl₃, AlCl₃ and MgCl₂.

The term “concrete aggregates” as used herein refers to inert granular materials such as sand, gravel, or crushed stone that, along with water and portland cement, are an essential ingredient in concrete. Non-limiting examples of aggregates are fine aggregates generally consist of natural sand or crushed stone with most particles passing through a ⅜-inch sieve, and coarse aggregates comprising particles greater than 0.19 inch, but generally between ⅜ and 1.5 inches in diameter.

The term “mortar shell” as used herein refers to a hardened hydrated cement shell, which forms the surface of recycled concrete aggregates. This shell is composed of fine aggregates, cement and water, and is formed during concrete curing. Mortar shell contains various basic components, such as calcium silicate hydrate (CSH) and Ca(OH)₂, that react with and neutralize HCl, which results in dissolution of the mortar shell into inorganic salts.

The term “RCA fines”, as used herein refers to RCA fractions passing through a sieve, e.g., 325 mesh (45 microns).

Some embodiments provide a method of increasing the pH of a body of saline water comprising:
a) contacting saline water obtained from the body of saline water with an electrolyzer to obtain a liquid rich in one or more metal hydroxide and a liquid rich in HCl;
(b) contacting the body of saline water with the liquid rich in one or more metal hydroxide of step (a);
(c) contacting inorganic waste with the liquid rich in HCl of step (a) to form recovered concrete aggregates and a liquid rich in inorganic salts; and
(d) optionally repeating steps (a)-(c).

In some embodiments, the foregoing method further comprises separating the recovered concrete aggregates from the liquid rich in inorganic salts of step (c).

In some embodiments, step (a)-(c) are repeated using the same batch of inorganic waste. In some embodiments, step (a)-(c) are repeated using the same batch of inorganic waste 2-15 times, for example, 2 times, 3 times, 4 times, 5 times, 6 times, 7 times, 8 times, 9 times, 10 times, 11 times, 12 times, 13 times, 14 times, or 15 times.

In some embodiments, each of the steps of the method are repeated continuously.

In some embodiments, contacting the inorganic waste with the liquid rich in HCl of step (c) occurs in a tumbler. In some embodiments, the tumbler comprises a rotating drum reactor. In some embodiments, the tumbler is rotated from about 1-150 rpm, for example, about 1-5 rpm, about 1-10 rpm, about 1-20 rpm, about 1-30 rpm, about 1-40 rpm, about 1-50 rpm, about 1-60 rpm, about 1-70 rpm, about 1-80 rpm, about 1-90 rpm, about 1-100 rpm, about 1-110 rpm, about 1-120 rpm, about 1-130 rpm, about 1-140 rpm, about 1-150 rpm, about 2-10 rpm, about 10-20 rpm, about 20-30 rpm, about 30-40 rpm, about 40-50 rpm, about 50-60 rpm, about 60-70 rpm, about 70-80 rpm, about 80-90 rpm, about 90-100 rpm, about 100-110 rpm, about 110-120 rpm, about 120-130 rpm, about 130-140 rpm, or about 140-150 rpm.

In some embodiments, contacting the inorganic waste with the liquid rich in HCl of step (c) occurs from about 1-100 h, for example, about 1-2 h, about 1-3 h, about 1-4 h, about 1-5 h, about 1-10 h, about 1-20, about 1-30 h, about 1-40 h, about 1-50 h, about 1-60, about 1-70 h, about 1-80 h, about 1-90 h, about 1-99 h, about 5-10 h, about 10-20 h, about 20-30 h, about 33-40 h, about 40-50 h, about 50-60 h, about 60-70 h, about 70-80 h, about 80-90 h, or about 90-100 h.

In some embodiments, the liquid rich in HCl of step (c) has an HCl concentration of about 0.1 to about 5.0 M, for example, about 0.1 M, about 0.2 M, about 0.3 M, about 0.4 M, about 0.5 M, about 0.6 M, about 0.7 M, about 0.8 M, about 0.9 M, about 1.0 M, about 1.1 M, about 1.2 M, about 1.3 M, about 1.4 M, about 1.5 M, about 1.6 M, about 1.7 M, about 1.8 M, about 1.9 M, about 2.0 M, about 2.0 to about 2.5 M, about 2.5 to about 3 M, about 3 to about 3.5 M, about 3.5 to about 4.0 M, about 4.0 to about 4.5 M, or about 4.5 to about 5.0 M.

In some embodiments, the liquid rich in HCl of step (c) comprises NaCl.

In some embodiments, the ratio of the number of moles of active ingredients, such as CaO, MgO, Ca(OH)₂, in inorganic to the number of moles of HCl in the liquid rich in HCl of step (c) is about 1:1 to about 1:10, for example about 1 kg of inorganic waste, containing about 85 g or 1.5 mol of CaO, is treated with about 3 mole of HCl in the liquid rich in HCl of step (c). In some embodiments, the ratio of the number of moles of active materials in inorganic waste to the number of moles of HCl in the liquid rich in HCl of step (c) is about 1:1. In some embodiments, the ratio is about 1:1.5. In some embodiments, the ratio is about 1:2. In some embodiments, the ratio is about 1:2.5. In some embodiments, the ratio is about 1:3. In some embodiments, the ratio is about 1:3.5. In some embodiments, the ratio is about 1:4. In some embodiments, the ratio is about 1:4.5. In some embodiments, the ratio is about 1:5. In some embodiments, the ratio is about 1:5.5. In some embodiments, the ratio is about 1:6. In some embodiments, the ratio is about 1:6.5. In some embodiments, the ratio is about 1:7. In some embodiments, the ratio is about 1:7.5. In some embodiments, the ratio is about 1:8. In some embodiments, the ratio is about 1:8.5. In some embodiments, the ratio is about 1:9. In some embodiments, the ratio is about 1:9.5. In some embodiments, the ratio is about 1:10.

In some embodiments, the inorganic waste contains CaO. In some embodiments, the molar excess of HCl used to treat the inorganic waste containing CaO is about 1%-25% in excess required to neutralize the CaO to CaCl₂ and H₂O, e.g., about 2%-20%, about 4%-18%, about 6%-15%, about 8%-12%, about 1-5%, about 5-10%, about 10-15%, about 15-20%, or about 20-25% in excess.

In some embodiments, the recovered concrete aggregates have a water absorption of about 0.5% to about 3%, e.g., about 0.5%, about 1%, about 1.5%, about 2%, about 2.5%, or about 3%. In some embodiments, the recovered concrete aggregates have a water absorption of about 1% to about 2%. In some embodiments, the recovered concrete aggregates have a water absorption of about 0.5% to about 2%. In some embodiments, the recovered concrete aggregates have a water absorption of about 1% to about 1.5%.

In some embodiments, each of the steps of the method (a)-(c) are repeated continuously.

In some embodiments, the electrolyzer comprises a membrane electrodialysis (MED) cell.

In some embodiments, the electrolyzer comprises a bipolar electrodialysis (BPMED) cell.

In some embodiments, the inorganic waste comprises recycled concrete aggregates (RCA).

In some embodiments, the inorganic waste comprises incinerator bottom ash aggregates (IBAA).

In some embodiments, the inorganic waste comprises a mixture of RCA and IBAA.

In some embodiments, the one or more metal hydroxide is comprised of alkali metal hydroxide, alkali earth metal hydroxide, or a combination thereof. In some embodiments, the one or more metal hydroxide is comprised of LiOH, NaOH, KOH, RbOH, CsOH, Be(OH)₂, Mg(OH)₂, Ca(OH)₂, Sr(OH)₂, Ba(OH)₂, or a combination thereof.

In some embodiments, the one or more metal hydroxide is comprised of alkali metal hydroxide. In some embodiments, the one or more alkali metal hydroxide is comprised of LiOH, NaOH, KOH, RbOH, or CsOH, or a combination thereof.

In some embodiments, the one or more metal hydroxide is comprised of alkali earth metal hydroxide. In some embodiments, the one or more alkali earth metal hydroxide is comprised of Be(OH)₂, Mg(OH)₂, Ca(OH)₂, Sr(OH)₂, Ba(OH)₂, or a combination thereof.

In some embodiments, the foregoing method further comprises removing CO₂ from the liquid rich in HCl of step (a) prior to contacting the inorganic waste with the liquid rich in HCl.

In some embodiments, the foregoing method further comprises removing CO₂ evolved during treatment of the inorganic waste with HCl from the liquid rich in inorganic salts of step (c).

In some embodiments, the inorganic waste is tumbled in water prior to contacting with the liquid rich in HCl in step (c).

In some embodiments, the foregoing method further comprises contacting the liquid rich in inorganic salts of step (c) with RCA fines. In some embodiments, the contacting the liquid rich in inorganic salts of step (c) with RCA fines is performed for about 15 seconds to about 15 minutes. In some embodiments, the contacting the liquid rich in inorganic salts of step (c) with RCA fines is performed for about 15 seconds to about 1 minute, e.g., about 15 seconds, about 20 seconds, about 30 seconds, about 40 seconds, about 50 seconds, or about 1 minute. In some embodiments, the contacting the liquid rich in inorganic salts of step (c) with RCA fines is performed for about 1 minute to about 15 minutes, e.g., about 1 minute, about 2 minutes, about 3 minutes, about 4 minutes, about 5 minutes, about 6 minutes, about 7 minutes, about 8 minutes, about 9 minutes, about 10 minutes, about 11 minutes, about 12 minutes, about 13 minutes, about 14 minutes, or about 15 minutes.

In some embodiments, the contacting the liquid rich in inorganic salts of step (c) with RCA fines is performed such that the wt of RCA fines:volume of liquid rich in inorganic salts of step (c) is about 1:5 to about 1:25, e.g., about 1:5, about 1:6, about 1:7, about 1:8, about 1:9, about 1:10, about 1:11, about 1:12, about 1:13, about 1:14, about 1:15, about 1:16 about 1:17, about 1:18, about 1:19, about 1:20, about 1:21, about 1:22, about 1:23, about 1:24, or about 1:25. In some embodiments, the contacting the liquid rich in inorganic salts of step (c) with RCA fines is performed such that the wt ratio of RCA fines:volume of liquid rich in inorganic salts of step (c) is about 1:25 to about 1:100, e.g., about 1:25, about 1:30, about 1:35, about 1:40, about 1:45, about 1:50, about 1:55, about 1:60, about 1:65, about 1:70, about 1:75, about 1:80, about 1:85, about 1:90, about 1:95, or about 1:100.

In some embodiments, the contacting the liquid rich in inorganic salts of step (c) with RCA fines is performed with agitation. In some embodiments, the contacting the liquid rich in inorganic salts of step (c) with RCA fines is performed with agitation in a rotary tumbler.

In some embodiments, the contacting the liquid rich in inorganic salts of step (c) with RCA fines is followed by filtration to separate the residual RCA fines from the liquid rich in inorganic salts.

In some embodiments, the contacting the liquid rich in inorganic salts of step (c) with RCA fines provides a liquid rich in inorganic salts having pH of about 6-9, e.g., about 6, about 6.1, about 6.2, about 6.3, about 6.4, about 6.5, about 6.6, about 6.7, about 6.8, about 6.9, about 7, about 7.1, about 7.2, about 7.3, about 7.4, about 7.5, about 7.6, about 7.7, about 7.8, about 7.9, about 8, about 8.1, about 8.2, about 8.3, about 8.4, about 8.5, about 8.6, about 8.7, about 8.8, about 8.9, or about 9. In some embodiments, the contacting the liquid rich in inorganic salts of step (c) with RCA fines provides a liquid rich in inorganic salts having less than about 10 mg/L of Al, Fe, or Si content.

In some embodiments, the liquid rich in HCl of step (a) comprises NaCl.

In some embodiments, the foregoing method further comprises contacting the body of saline water with the liquid rich in inorganic salts of step (c). In some embodiments, the foregoing method further comprises contacting the liquid rich in inorganic salts of step (c) with RCA fines, then contacting it with the body of saline water. In some embodiments, contacting the liquid rich in inorganic salts of step (c) with RCA fines removes Al. Fe, and Si.

Some embodiments provide a system configured to perform the foregoing method.

In some embodiments, the system configured to perform the foregoing method comprises an electrolyzer comprising cathode materials selected from the group consisting of carbon fiber, carbon paper, carbon nanotube, carbon cloth, Ni—Al Raney nickel alloys, low carbon steel, and Ni-, Pt-, Pd-, Ag-, Au-, Zn-, Fe-, Ru-, Ir-, Mo- or Cd-based alloys or compounds.

In some embodiments, the system configured to perform the foregoing method comprises an electrolyzer comprising anode materials selected from the group consisting of platinum, dimensionally stable anodes, ruthenium-iridium-titanium mixtures, and mixtures of carbon, Ti, Zr, Hf, Nb, Ta, W, Al, Bi, Pt, Ir, Rh, Ru, Os, Pd, Cu, Ag, Au, Fe, Co, Ni, Sn, Si, Pb, Sb, As, Cr, and Mn.

In some embodiments of the method or system described herein, the body of saline water is selected from the group consisting of an ocean, a sea, a canal, a reservoir, a lake, and a river. In some embodiments of the method or system described herein, the body of saline water is ocean. In some embodiments of the method or system described herein, the body of saline water is a sea. In some embodiments of the method or system described herein, the body of saline water is a canal. In some embodiments of the method or system described herein, the body of saline water is a reservoir. In some embodiments of the method or system described herein, the body of saline water is a lake. In some embodiments of the method or system described herein, the body of saline water is a river.

In some embodiments of the method or system described herein, the saline water obtained from the body of saline water is brine. In some embodiments of the method or system described herein, the brine is from desalination of water obtained from the body of saline water.

Electrolysis: Several cell structures and electrolysis strategies can be implemented herein. Some examples are explained below.

A two-membrane salt splitting cell can be used in the methods disclosed herein, with water oxidation, i.e., H₂O→½O₂+2H⁺+2e⁻, on the anode side and water reduction, i.e., 2H₂O+2e⁻→H₂+2OH⁻, on the cathode side. The electrolyzer can include an anion exchange membrane (AEM) and a cation exchange membrane (CEM). In some embodiments, the AEM and CEM can be replaced with a bipolar membrane. When a large enough voltage is applied to the electrodes, a water splitting reaction takes place. At the anode, water is oxidized to molecular oxygen, and the anions are pulled from the central reservoir, which results in an acid solution in the anode electrolyte. Meanwhile at the cathode, water is reduced to molecular hydrogen, and cations are pulled from the central reservoir, creating a base electrolyte in the cathode reservoir. The thermodynamic voltage for the reaction is 1.23 V. In addition, a possible auxiliary device to this setup is a H₂+O₂ fuel cell, which can cover part of the electricity cost.

Another possible electrolyzer that can be used in the methods disclosed herein is a classic chlor-alkali electrolyzer. A cation membrane separates the anode side from the cathode side. During electrolysis, chloride ions are oxidized to chlorine, i.e., 2Cl⁻→Cl₂+2e⁻, at the anode, and water is reduced to hydrogen at the cathode. A fuel cell is required to convert hydrogen and chlorine into HCl gas.

Further, a bipolar membrane electrodialysis cell (BPMED; e.g., an electrodialysis cell as described in U.S. Pat. No. 9,586,181) can be used in the methods disclosed herein.

Herein describes and demonstrates through non-limiting examples that the low concentration waste acid produced by the growing electrochemical OAE industry is suitable for RCA processing, which enables not only a path for the neutralization of hundreds of megatonnes of HCl but also affords an additional revenue stream via the valorization of demolition wastes. The methods described herein facilitate the removal of mortar from RCA using dilute waste acid, for example from BPMED-derived (0.5 M HCl). The methods described herein enable integration of electrochemical OAE and concrete recycling to create a path to reach potentially hundreds of mega tonnes of negative emissions/yr while keeping up to a gigatonne of construction and demolition (C&D) waste out of landfills per year.

In some embodiments, the methods described herein use a tumbler for RCA processing. In some embodiments, the tumbler is a rotary drum reactor. In some embodiments, the rotary drum reactor facilitates the grinding of RCA particles against one another, rupturing the silica shell that impedes the further infiltration of acid into the mortar. In some embodiments, the rotary drum is constructed from an acid-resistant and mechanically strong material. In some embodiments, the rotary drum is constructed from high-density polyethylene (HDPE) or polyethylene high-density (PEHD) or other acid-resistant plastics. In some embodiments, the rotary drum is constructed from metals such as titanium, tantalum, silver, gold, and nickel-based alloys like Alloy B-2, Alloy C276, and Alloy 22. In some embodiments, the rotary drum is constructed from a metal or metal alloy able to withstand mild HCl (e.g., about 1-10% w/w) at moderately elevated temperatures (e.g., below about 50 °C) while maintaining structural integrity under mechanical stress. In some embodiments, the rotary drum is constructed from an acid-resistant layer with a thickness ranging from about 3 mm to about 100 mm can be clad onto a less expensive metal body.

In some embodiments, the water absorption (WA) of the tested RCA decreases dramatically, from around 6.5% by more than 80% to approximately 0.5-1%. This reduction in WA is considerably more than previous reports that employ higher acid concentrations, yet achieved significantly lower WA.

Herein also discloses analysis of the final neutralized acid waste stream and shows that final alkalinization with RCA fines restores the waste stream pH to ~7 as well as precipitates heavy metals and silica, resulting in a waste stream with harmless ions already found in seawater, i.e. calcium and magnesium. This waste stream is thus likely safely disposable using suitable outflow diffusers, as used currently by the desalination industry.

In some embodiments, the inorganic waste comprises adsorbed CO₂. In some embodiments, the inorganic waste comprises RCA waste containing some degree of adsorbed CO₂ from contact with air.

As described herein, the degree of pre-carbonation of the concrete aggregates may be assessed. This assessment is germane to the methods described herein because available RCA stocks are much more pre-carbonated than those which would result from fresh demolition projects, which would be expected if this industry were to reach a mature, steady-state stage. The natural, passive carbonation of concrete and concrete wastes should be taken into account when assessing the additionality of an OAE intervention. Due to the diffusion limited process, concrete wastes carbonate only slowly and incompletely, especially when buried in landfills. Furthermore, the storage of CO₂ as solid carbonates is 40% less efficient than storing bicarbonates in the ocean. Therefore, usage of concrete wastes for electrochemical OAE-derived acid neutralization supports a much greater amount of negative emissions in a much shorter time span.

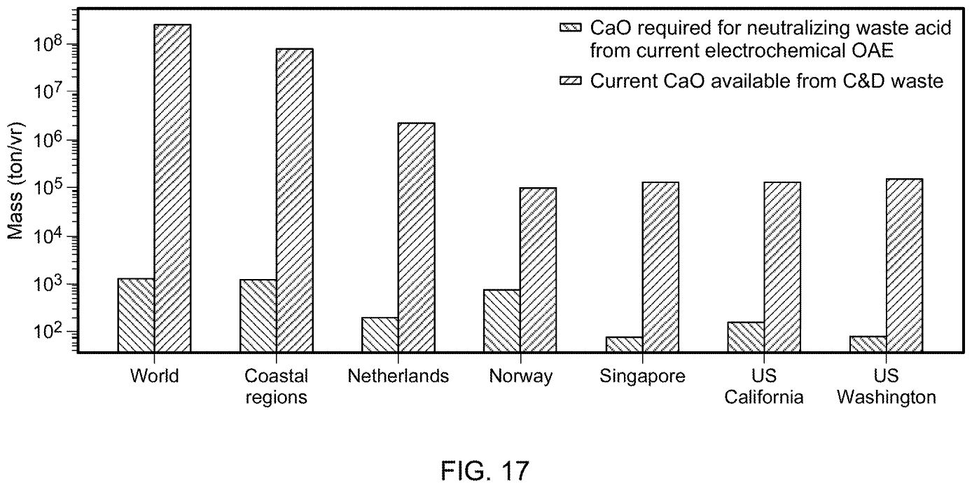

The current disclosure offers a means to match OAE plant capacities with C&D waste. Currently, the C&D waste generated in the same regions corresponds to an amount of CaO required to neutralize the acid produced by each plant is dwarfed by the CaO readily available from C&D waste (FIG. 17). This abundance of alkalinity from waste streams could alleviate constraints on acid disposal for OAE startups and provide extra revenue streams from landfill avoidance and sale of clean recycled aggregates, facilitating their expansion. Globally, the annual generation of billions of tons of construction waste could yield millions of tons of CaO for neutralizing acid waste corresponding to significant CO₂ removal potential. Enabling OAE technologies to grow is therefore a substantial step towards meeting negative emission goals set out the IPCC.

In terms of scalability, the methods described herein enable sequestration of CO₂ into ocean water on large scale. In principle, each mol of alkalinity released in the ocean can absorb up to 0.8 mol of CO₂. Hence, to absorb 1 tonne of CO₂, 1.136 dry tonnes of NaOH need to be generated by an OAE process. Negative emissions credits are anticipated to increase with time, providing increasing economic incentive to utilize the methods described herein. For example, for every dry tonne of NaOH used in the electrochemical OAE process, approximately 0.91 dry tonnes of HCl are produced, or 1.04 tonnes per CO₂ absorbed by ocean. This acid can then be used to generate 6.0-6.5 tonnes of clean aggregate from 8.5 tons of RCA waste. This generates potential additional revenue. Additionally, tipping fees for landfill avoidance can be claimed, providing economic incentives for the upcycling process. Another benefit of the methods described herein is the avoidance of disposing the waste acid, which comes at a high cost in certain places.

Some embodiments provide a mobile apparatus for performing the methods described herein, for example, an apparatus that is configured to be moveable and/or is attached to a mechanism for moving the apparatus from location to location.

For example, an additional aspect of this disclosure provides a mobile processing plant for increasing the pH of a body of saline water, the plant configured to enable a process comprising:
(a) contacting saline water obtained from the body of saline water with an electrolyzer to obtain a liquid rich in one or more metal hydroxide and a liquid rich in HCl;
(b) contacting the body of saline water with the liquid rich in one or more metal hydroxide of step (a);
(c) contacting inorganic waste with the liquid rich in HCl of step (a) to form recovered concrete aggregates and a liquid rich in inorganic salts; and
(d) optionally repeating steps (a)-(c).

In some embodiments, the mobile processing plant is comprised of a railroad car, which is transported by rail to the site where the inorganic waste and the body of saline water is accessible. In some embodiments, the mobile processing plant is comprised of a trailer, which is transported by road to the site where the inorganic waste and the body of saline water is accessible. In some embodiments, the mobile processing plant is comprised of a truck, which travels by road to the site where the inorganic waste and the body of saline water is accessible. In some embodiments, the mobile processing plant is comprised of a barge, which is transported by water to the site where the inorganic waste and the body of saline water is accessible. In some embodiments, the mobile processing plant is comprised of a ship which travels by water to the site where the inorganic waste and the body of saline water is accessible. In some embodiments, the mobile processing plant is comprised of an aircraft which travels by air to the site where the inorganic waste and the body of saline water is accessible.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

### EXAMPLES

### Materials and Methods

ACS grade 37% HCl, ACS grade NaCl, 99% acetic acid and concentrated H2SO4 were obtained from Lab Alley or Sigma-Aldrich. The Biopharm phenolphthalein pH Indicator 1% solution was purchased from Amazon. Coarse recycled concrete aggregates (RCA) of size 9-20 mm were sourced from Pleasanton, CA. The mortar content was determined by the method described by A. Akbarnezhad, et al. (Journal of Testing and Evaluation, 41(3), 20120026 (2013)). The RCA samples were first oven-dried and weighed. Then, the samples were immersed in 3 M HCl solution for 24 hours under continuous rotary agitation. After soaking, the samples were washed, sieved over a #4 screen, dried, and weighed again. The weight loss was used to calculate the mortar content. The procedure was repeated if visual inspection revealed the presence of mortar. The alkaline content, i.e., the sum of CaO, Al₂O₃, MgO and Fe₂O₃, measured by this method was about 8.5 w/w % on average.

### RCA-Acid Reactions:

During the acid treatment, coarse RCA samples were submerged in acid mixtures of various types, volume and concentration, for varying duration. The reactions were either agitated using a Labnique™ orbital shaker (Model number: MT-201-BD) at 120 rpm or a rotary drum, i.e., QuikStir 5 gallon rotary mixer (SKU: BM-37005) from ConcreteDecorStore, at 60 rpm. The pH of certain reactions was monitored with a pH probe connected to an Arduino Uno to track the reaction's progress.

### Water Absorption:

Once the specified reaction time elapsed, the liquid was decanted from the reaction mixture into a separate reservoir. The solids were rinsed with water, spread on a metal screen with a #4 mesh (Gilson Company, Inc.), and rolled on the screen to separate fine and coarse aggregates. The extracted coarse aggregates were rinsed again before measuring water absorption. Water absorption measurements for coarse natural aggregates (Pleasanton, CA), RCA, and extracted aggregates were conducted in accordance with ASTM C127-12. A sample of coarse aggregate was immersed in water for 24 hours to fill the pores. The sample was then removed from the water and surface-dried to remove any visible water films. The mass of the sample was determined in this saturated-surface-dry (SSD) condition. Finally, the sample was oven-dried and weighed again. The difference between the SSD mass and the oven-dry mass was used to calculate the water absorption, i.e., WA=(M_{SSD}−M_{OD})/M_{OD}×100, where WA is the water absorption, M_{SSD} is the SSD mass and M_{OD} is the oven-dried mass.

### Solution Analysis:

The post-process acid was subjected to analysis by inductively coupled plasma optical emission spectroscopy (ICP-OES) and ion chromatography (IC) at Eurfins EAG Materials Science, LLC. 50 mL samples were sent to Eurofins EAG Materials Science, LLC for analysis and tested for the following elements: Al, Ca, Fe, Mg, Si, Ba, Cd, K, Pb, Sb, and Na, through ICP-OES and chloride (Cl⁻) and sulfate (SO₄²⁻) through IC. The ICP-OES was performed on a Perkin Elmer Optima 7300V with Teon GemCone nebulizer. The IC instrument used was a Metrohm 940 Professional IC Vario with a Metrohm ProfIC Conductivity Detector. The sensitivity limit of the ICP-OES analysis is 10 mg/L and that for IC is 0.5 ppm.

### Phenolphthalein Test:

A 1% phenolphthalein solution was applied to the surface of test samples as a qualitative pH indicator. The carbonated surface, anticipated to exhibit a near-neutral pH, remained colorless upon contact with the indicator. Conversely, the uncarbonated surface, characterized by a high alkaline content, yielded a distinct pink coloration.

### Instrumental Gas Analysis:

The CO₂ content of RCA test samples was quantitatively determined via instrumental gas analysis (IGA) utilizing a LECO RC612 analyzer. Samples were placed in quartz boats within a combustion tube and heated under a nitrogen ow of 3.0 L/min, with a temperature ramp from 70 °C to 1000 °C at a rate of 100 °C/min, followed by a 50-second hold at 1000 °C. Evolved CO₂ was measured using infrared (IR) detectors. Two RCA size fractions were analyzed: 9.5-12.7 mm and 6.7-9.5 mm. The inherent heterogeneity of RCA composition, consisting of both rock-like and mortar-like components, was accounted for by randomly sampling 3 batches of 100 grams for the 9.5-12.7 mm fraction and 50 grams for the 6.7-9.5 mm fraction. These components were differentiated through visual inspection, with mortar-like fragments exhibiting a rough and irregular surface texture compared to the smooth and shiny texture of rock-like fragments. Additionally, the density of mortar-like components was notably lower than that of rock-like components, aiding in their identification. The mass ratio of rock-like to mortar-like components was then determined for each fraction. Similarly, the CO₂ content of mortar cylinder samples was quantitatively determined via the LECO RC612 analyzer.

### Example 1. Treatment of Recycled Cement Aggregates with Aqueous HCl

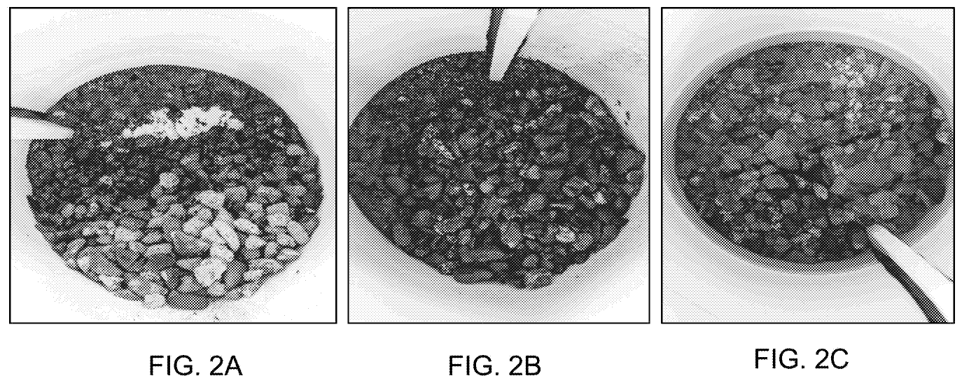

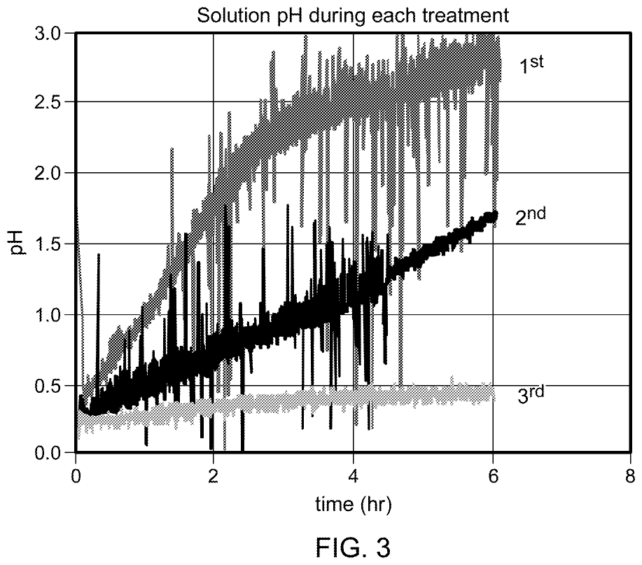

Herein describes the results of treating a 5 kg batch of RCA with 0.5 M HCl (equivalent to an acid stream produced by BPMED electrolyzer) in three portions of about 10 L each. The RCA was reacted with 0.5 M HCl (aq.) in a rotary drum reactor under 60 rpm rotation for 6 h after each 10 L portion of HCl was added. The solution pH was monitored continuously during reaction. The pH and the conductivity of the reaction solution were measured before and after each reaction period. The total reaction time of RCA with HCl was 18 h. The appearance of the RCA after each treatment period is shown in FIG. 2. The extent of mortar shell on the aggregates was reduced after each treatment period. The total treatment time for FIGS. 2A, 2B, and 2C was 6 h, 12 h, and 18 h, respectively. The solution pH during each treatment period of RCA with 0.5 M HCl (aq.) is shown in FIG. 3. The pH was initially low after each portion of HCl was added, then gradually increased as the mortar shell material reacted with and neutralized the acid. The reaction rate appeared to be reduced after each successive portion of acid was added (as evidenced by the reduced rate of pH change), consistent with near complete removal of the mortar shell from the surface of the aggregates. A summary of the pH and conductivity at the beginning and end of each treatment period is shown in Table 1.

TABLE 1
Initial and final pH and conductivity of acid treatment batches

| Treatment | pH | pH | Conductivity | Conductivity |
|---|---|---|---|---|
| period | (initial) | (final) | (initial) | (final) |
| 1 | 0.74 | 3.17 | 185.2 | 43.17 |
| 2 | 0.54 | 1.82 | 185.0 | 46.16 |
| 3 | 0.37 | 0.74 | 187.4 | 105.6 |

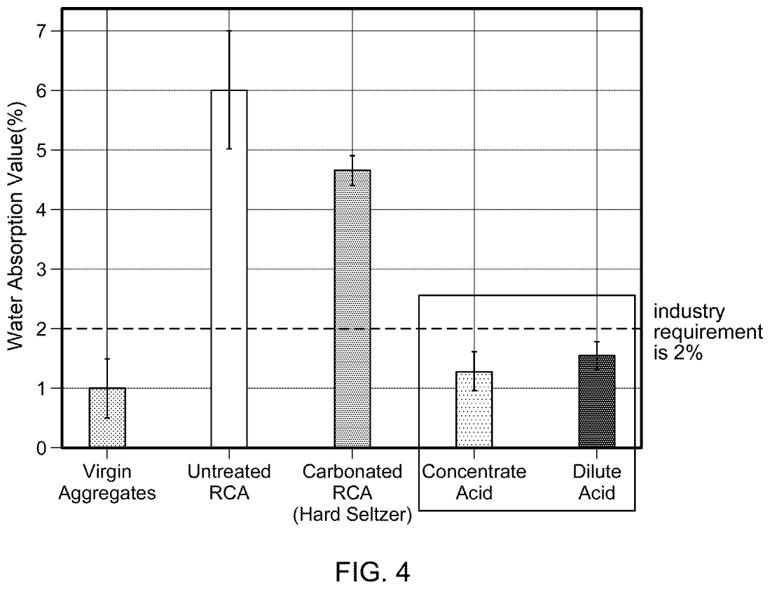

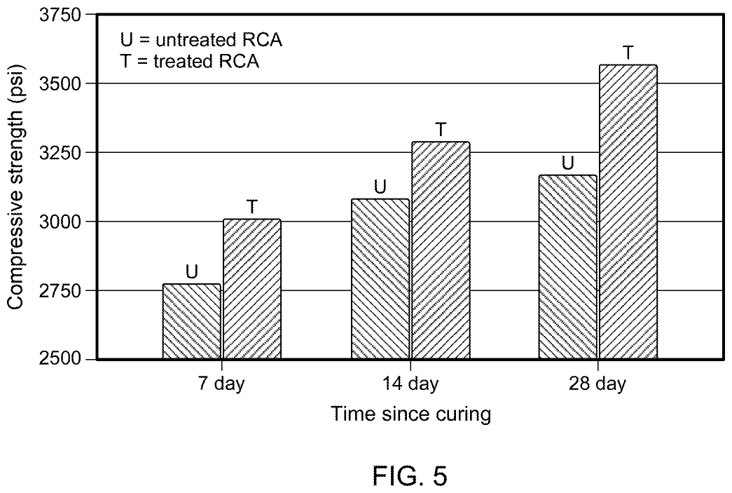

The water absorption of RCA was reduced by about 80% following the acid treatment, achieving a level similar to virgin (natural) aggregates (FIG. 4). Cement prepared with acid treated RCA was stronger than cement prepared with untreated RCA, as evidenced by compression tests of concrete cylinders. Concrete cylinders made of acid treated RCA were 10% stronger at 7 and 14 days of curing than concrete cylinders made of untreated RCA (FIG. 5).

The results indicate that 0.5 M HCl is effective in treating RCA, as evidenced by reducing the water absorption by about 80% after acid treatment and resulting in higher compression strength of cement prepared with treated RCA. The resulting acid-treated RCA is within the industry requirements. The 0.5 M HCl (aq.) used in this example can be obtained from saline water using the methods described herein.

### Example 2. Suitability of OAE-Derived Waste Acid for Effective Removal of Mortar from RCA

Herein demonstrates an acid wash method that allows the effective removal of mortar from RCA using waste acid produced from an electrochemical OAE process. Concentrated acids (>2 M) such as HCl, HNO₃ and H₂SO₄ have been used to determine the mortar amount but the effect of more dilute (<1 M) acid on mortar removal was uncharacterized. Using a benchtop setup, some of the experiments presented in the literature were replicated. In these experiments, 100 grams of coarse RCA, containing ~8.5 g or 0.15 mol of CaO equivalence, were treated with different types of acids, at various concentrations, and for various duration. The reaction mixture was agitated at 120 rpm by an orbital shaker. The reaction conditions and the resulting WA of the treated coarse aggregates are summarized in Table 2. The WA of water-washed untreated coarse RCA (6.8±0.5%) was the baseline.

TABLE 2
Summary of orbital-shaker agitated acid treatment of course RCA

| | | | | | | | WA |
|---|---|---|---|---|---|---|---|
| | | | | Mols | | | reduc- |
| No. | acid | Conc/M | Vol/mL | acid | TT/h* | WA/% | tion/% |
| 1 | HCl | 3 | 300 | 0.9 | 72 | 1.3 ± 0.2 | 78 ± 12 |
| 2 | HCl | 3 | 150 | 0.45 | 72 | 1.3 ± 0.3 | 79 ± 20 |
| 3 | HCl | 1.5 | 300 | 0.45 | 72 | 1.4 ± 0.5 | 76 ± 27 |
| 4 | HCl | 1.5 | 150 | 0.23 | 72 | 2.7 ± 2.2 | 55 ± 45 |
| 5 | HCl | 1 | 200 | 0.2 | 72 | 1.7 ± 1.0 | 72 ± 42 |
| 6 | HCl | 0.5 | 200 | 0.1 | 72 | 4.8 ± 0.2 | 20 ± 1 |
| 7 | HCl | 0.5 | 700 | 0.35 | 88 | 2.2 ± 1.1 | 63 ± 31 |
| 8 | HOAc | 17.3 | 300 | 5.19 | 72 | 3.0 ± 1.3 | 50 ± 21 |
| 9 | H₂SO₄ | 3 | 300 | 1.8 | 72 | 4.2 ± 0.9 | 30 ± 6 |

*TT = treatment time;
WA = water absorption

As shown in Table 2, of the three types of acid tested, only HCl was able to effectively remove the mortar. Without wishing to be bound by theory, the limited efficacy of H₂SO₄ may be due to the low solubility of CaSO₄, which, according to the le Chatelier principle, would drive the reaction, i.e. H₂SO₄+CaO→CaSO₄+H₂O, toward the reactants. Alternatively, the CaSO₄ crashed out as a solid and passivated the reactive surface.

Meanwhile, 99% acetic acid (pH~4) was too weak to dissolve the mortar. HCl of higher concentration and larger volume (entry numbers 1-3) effectively removed mortar from RCA and reduced WA by more than 70%, largely attributed to the excess of acid compared to the stoichiometric amount (0.3 mol) needed. When the amount of acid was less than the stoichiometric amount, the effectiveness was limited and the variance was high, as shown by the results from entry numbers 4, 5 and 6. Conversely, although entry number 7 involved an excess of acid, the high final WA and its variance suggests limitations due to the low acid concentration. Moreover, aluminosilicate gel formed during the reaction and hindered the diffusion of acid from the bulk solution to deeper mortar layers. According to Fick's first law of diffusion, the diffusion rate is determined by the concentration gradient across the barrier, thus a lower bulk concentration resulted in a sluggish reaction. In this setup, using 0.5 M acid was insufficient to produce aggregates with a WA below 2%. These results align with previous reports indicating that high concentration and volume of HCl are necessary to remove mortar from RCA. However, such conditions are incompatible with the waste acid (~0.5 M) generated by electrochemical OAE. Hence, a more efficient agitation method to remove the aluminosilicate gel from the reaction surface is required for the utilization of the waste acid.

Drawing inspiration from the utilization of ball mills within the mining sector, a rotary drum reactor was employed to augment mechanical interactions among RCA particles. This approach aimed to physically abrade and remove mortar and the aluminosilicate gel layer formed during acid treatment. It is known that continuous Los Angeles (LA) abrasion of coarse RCA in a rotating drum with steel spheres-analogous to a ball mill process—can effectively reduce water absorption and enhance the mechanical properties of the resultant concrete. It is also known that pre-treating RCA with acetic acid prior to mechanical grinding achieved a notable reduction in WA to approximately 2%. These concepts underscore the efficacy of grinding in disrupting the mortar matrix and exposing the underlying natural aggregates. Without wishing to be bound by theory, it was hypothesized that the synergistic effect of simultaneous grinding and acid soaking may amplify the effectiveness of each individual process. Specifically, grinding may facilitate the breakdown of the aluminosilicate gel, allowing for deeper acid penetration, while the acid weakens the mortar structure by consuming the alkaline content, rendering it even more susceptible to mechanical detachment.

### Example 3. Optimization of Rotary Drum Reactor

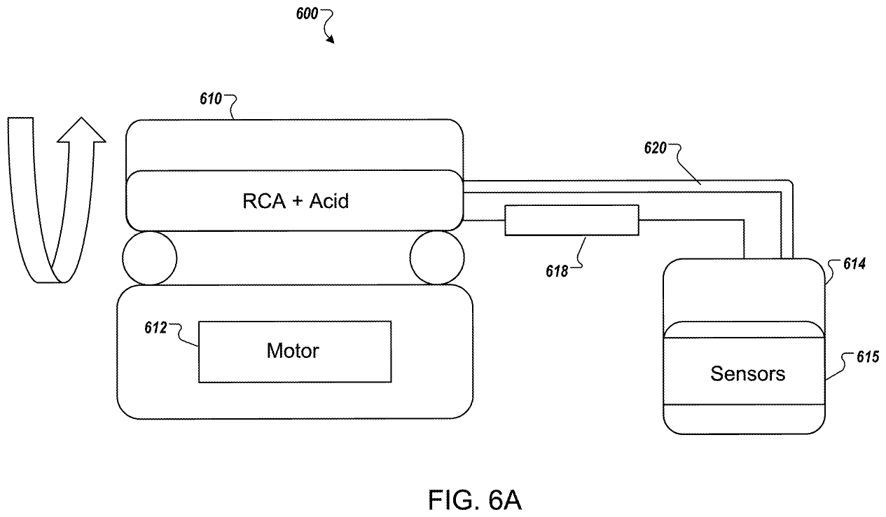

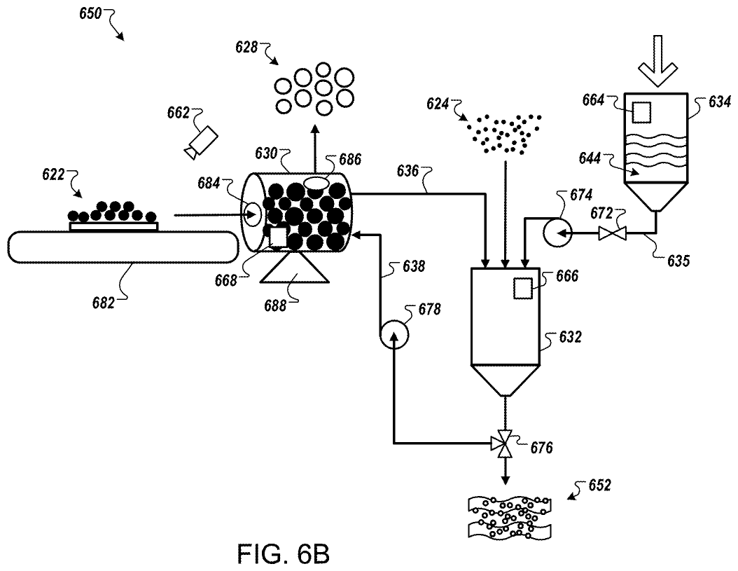

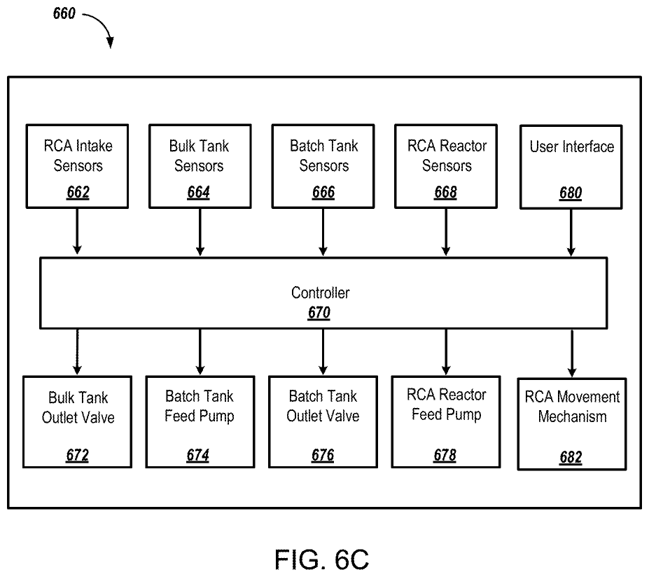

The current example focuses on elucidating the influence of various reaction parameters on the efficiency of mortar removal from RCA using a rotary drum reactor. FIG. 6A shows a simplified schematic of rotary drum reactor system 600 used for treating RCA. The system 600 includes a reactor 610, a motor 612, and an acid reservoir 614.

The reactor 610 can be a tumbling reactor such as a rotary drum reactor. The reactor can include a housing for containing RCA and acid. In some examples, the reactor is a rotary mixer. The motor 612 can be an industrial tumbler motor.

In some examples, the rotary drum is constructed from an acid-resistant and mechanically strong material. In some examples, the rotary drum is constructed from high-density polyethylene (HDPE) or polyethylene high-density (PEHD) or other acid-resistant plastics. In some examples, the rotary drum is constructed from metals such as titanium, tantalum, silver, gold, and nickel-based alloys like Alloy B-2, Alloy C276, and Alloy 22. In some examples, the rotary drum is constructed from a metal or metal alloy able to withstand mild HCl (e.g., about 1-10% w/w) at moderately elevated temperatures (e.g., below about 50 °C) while maintaining structural integrity under mechanical stress. In some examples, the rotary drum is constructed from an acid-resistant layer with a thickness ranging from about 3 mm to about 100 mm can be clad onto a less expensive metal body.

The acid reservoir 614 can include a heated jacket and sensors 615. The sensors 615 can include pH and conductivity sensors. The acid reservoir 614 can contain acid or acidified brine. The system 600 can include a pump 618 that is configured to feed acid from the acid reservoir 614 into the reactor 610. In some examples, the pump 618 is a peristaltic pump. The system 600 can include an acid recycle drip line 620 for returning acid from the reactor 610 to the acid reservoir 614.

During operation, RCA can be placed in the reactor 610. Acid can be pumped into the reactor 610 from the reservoir 614. The motor 612 can agitate (e.g., rotate) the reactor to mix the RCA and the acid. The sensors 615 can measure conditions in the acid reservoir 614 in order to determine a status of the reaction.

FIG. 6B shows an example system 650 for treating RCA. The system 650 includes an RCA reactor 630, an acid batch tank 632, and an acid bulk tank 634. Each of the RCA reactor 630, the acid batch tank 632, and the acid bulk tank 634 can include inlets port and outlet ports for RCA, for brine, or both.

The acid bulk tank 634 receives and stores acidified brine 644 (e.g., HCl) that is generated from the electrochemical process performed by the electrochemical OAE system 110. In some cases, the acid bulk tank 634 fills continuously or near continuously with acidified brine 644. When a batch of coarse RCA 622 is to be processed, a batch of acidified brine 644 can be transferred from the acid bulk tank 634 to the acid batch tank 632. The acidified brine 644 can be transferred from the acid bulk tank 634 through a feed line 635. The feed line 635 can include a bulk tank outlet valve 672, a batch tank feed pump 674, or both. The bulk tank outlet valve 672 can be operable to keep the brine 644 in the bulk tank 634 (e.g., when shut) and to permit flow of brine 644 from the bulk tank 634 to the batch tank 632 (e.g., when open). The pump 674 can be operable to pump the brine 644 from the bulk tank 634 to the batch tank 632.

During operation, a batch of acidified brine from the acid bulk tank 634 is fed into the acid batch tank 632 through the feed line 635. The batch of acidified brine then circulates between the fine reactor 632 and the coarse reactor 630 through supply line 638 and drain line 636. An outlet of the acid batch tank 632 can be connected to a valve 676. The valve 676 can be operable to keep acid inside the acid batch tank 632 to permit flow of acid from the acid batch tank 632 to the supply line 638, and to drain the acid batch tank 632.

The coarse RCA reactor 630 can be a rotary reactor (e.g., a rotary drum). The batch of unprocessed coarse RCA 622 is mixed with the acidified brine 644 in the RCA reactor 630. Over time during operation, the acidified brine 644 removes mortar from the batch of coarse RCA 622, resulting in processed coarse RCA 628. The processed coarse RCA 628 is suitable for used in concrete cement (see FIG. 4), and provides greater compression strength than untreated RCA (see FIG. 5). The removed mortar mixes with the brine, reducing acidity of the brine in the acid batch tank 632.

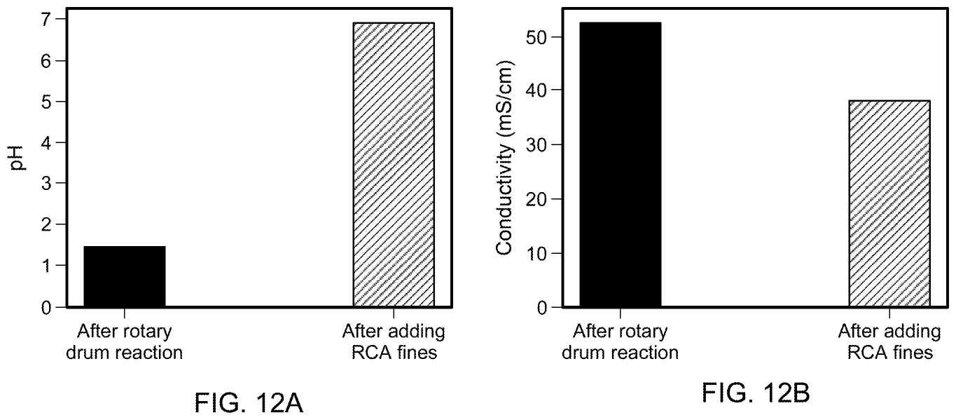

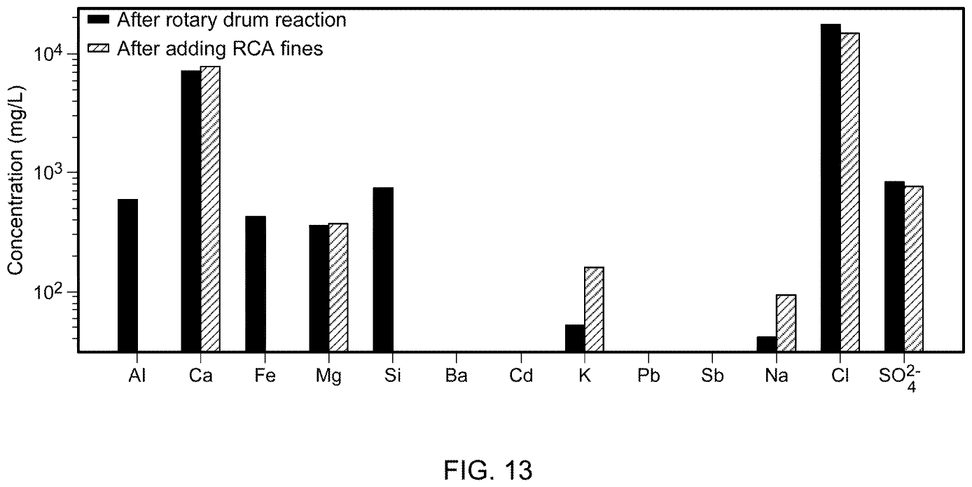

The acidity of the brine circulating between the RCA reactor 630 and the acid batch tank 632 decreases over time as the brine 644 is mixed with the coarse RCA 622 in the RCA reactor 630 and removes mortar from the coarse RCA. To further neutralize the acid, the acidic brine can be mixed with RCA fines 624 in the acid batch tank 632. In some examples, a batch of RCA fines 624 is introduced to the acid batch tank 632 after the processed coarse RCA 628 is produced, and the RCA fines further neutralize the acid from the acidic brine as shown in FIG. 12A. In some examples, a batch of RCA fines 624 is introduced to the acid batch tank 632 after the processed coarse RCA 628 is produced, and the RCA fines reduce the concentration of metal ions from the acidic brine as evidenced by a reduction in conductivity (see FIG. 12B) and (ICP-OES) and ion chromatography (IC) analysis (see FIG. 13).

When the brine in the acid batch tank 632 reaches a target acidity, a slurry 652 of brine and RCA fines can be removed from the acid batch tank 632 through the batch tank outlet valve 676. The slurry 652 can undergo a sieving process to remove the RCA fines 624 from the neutralized brine. The RCA fines 624 can be disposed, while the neutralized brine can be returned to the ocean.

Sensors can be used to monitor conditions in the system 650. For example, the acid batch tank 632 can include batch tank sensors 666 such as pH and conductivity sensors in order to measure qualities of fluid such as the pH and conductivity in the acid batch tank 632. The batch tank sensors 666 can also include, for example, temperature sensors, tank level sensors, or both. Similarly, the acid bulk tank 634 can include bulk tank sensors 664 that are operable to measure qualities of fluid (e.g., pH, conductivity) and other conditions (e.g., temperature, tank level) in the bulk tank 634.

The RCA reactor 630 can include sensors 668 that are operable to measure conditions in the RCA reactor 630. The RCA reactor sensors 668 can include pH sensors, conductivity sensors, temperature sensors, image sensors (e.g., cameras), tank level sensors, or any combination thereof. In some examples, the system 650 includes one or more RCA intake sensors 662. The RCA intake sensors 662 can include, for example, one or more cameras that are operable to observe the coarse RCA 622 entering the RCA reactor 630. Sensor data generated by the RCA intake sensors 662 can be used to adjust operations of the system 650. For example, a time required to remove mortar from the coarse RCA 622 may depend on the size and/or condition of the coarse RCA particles. Therefore, the time for processing the coarse RCA 622 in the RCA reactor 630 can be adjusted based on observations made using the RCA intake sensors 662.

FIG. 6C is a block diagram of an example control system 660 for the system 650 for treating RCA. The control system 660 includes a controller 670. The controller 670 can receive input from the sensors of the system 650. For example, the controller 670 can receive input from any of: the RCA intake sensors 662, the bulk tank sensors 664, the batch tank sensors 666, and the RCA reactor sensors 668.

The controller 670 can adjust operations of components of the system (e.g., valves, pumps, inlet ports, outlet ports, conveyors) by transmitting control signals to the various components of the system. For example, the controller 670 can operate valves and/or pumps in order to transport brine 644 throughout the system. The controller 670 can operate (e.g., open, shut, or change position of) the bulk tank outlet valve 672 and the batch tank outlet valve 676. The controller 670 can operate (e.g., start, stop, increase speed of, decrease speed of) the batch tank feed pump 674 and the RCA reactor feed pump 678.

In some examples, the controller 670 can operate the components of the system in order to move coarse RCA into and out of the RCA reactor 630. For example, the RCA reactor 630 can include an inlet port and an outlet port that are operable by the controller 670. Coarse RCA 622 can be delivered to, and taken away from, the RCA reactor 630 by RCA movement mechanisms 682 such as a conveyor.

In some examples, the controller 670 automatically operates components of the system 650 based on sensor data received from the sensors. In some examples, the controller 670 operates components of the system in response to receiving user input received through a user interface. For example, the controller 670 can receive a user input indicating to open a valve, and in response send a control signal to the valve to cause the valve to open.

In an example scenario, the controller 670 operates the movement mechanism 682 to move coarse RCA 622 to the RCA reactor 630. The controller 670 operates an inlet port 684 to permit ingress of the coarse RCA 622 into the RCA reactor 630. The controller 670 monitors the coarse RCA 622 entering the RCA reactor 630 using the RCA intake sensors. The controller 670 operates the bulk tank outlet valve 672 and the batch tank feed pump 674 to move brine 644 into the acid batch tank 632, and monitors the respective tank levels using the bulk tank sensors 664 and the batch tank sensors 666. The controller 670 operates the batch tank outlet valve 676 and the RCA reactor feed pump 678 to circulate the brine 644 between the acid batch tank 632 and the RCA reactor 630. The controller 670 operates a motor 688 to agitate the coarse RCA 622 and the brine 644 in the RCA reactor 630. The controller 670 monitors conditions within the RCA reactor 630 and the acid batch tank 632 using sensor data generated by the RCA reactor sensors 668 and the batch tank sensors 666, respectively. The controller 670 can determine, based on the sensor data, when the conditions have reached target conditions representative of the RCA processing being complete. The target conditions can include acidity in the acid batch tank satisfying first acidity and/or conductivity criteria. The target conditions can include images of the coarse RCA 622 showing a satisfactory amount of mortar. The controller 670 can stop the RCA processing by stopping operation of the motor 688 and the pump 678. The controller 670 can remove the processed coarse RCA 628 from the RCA reactor 630 through an outlet port 686. The controller 670 can operate one or more valves or ports to introduce the RCA fines 624 into the acid batch tank 632. The controller 670 can monitor conditions within the acid batch tank 632 using sensor data generated by the batch tank sensors 666. The controller 670 can determine, based on the sensor data, when the conditions in the acid batch tank have reached target conditions. The target conditions can include acidity in the acid batch tank 632 satisfying second acidity and/or conductivity criteria. The second criteria can be representative of the brine being sufficiently neutralized (e.g., having a pH value between 6 and 9). The controller 670 can operate the batch tank outlet valve 676 to drain the slurry of RCA fines 624 and brine 644 from the acid batch tank 632.

In the scenario above, any of the operations performed by the controller 670 can be performed automatically based on received input such as sensor data generated by sensors. Any of the operations performed by the controller 670 can be performed automatically based on received user input. Each of the operations described as being performed by the controller 670 can optionally be performed manually by a human. For example, sensor data generated by sensors of the system 650 can be presented to a human (e.g., through the user interface). The human can operate components of the system 650 manually by hand (e.g., by opening or shutting a valve). The human can operate components of the system 650 manually using individual control mechanisms (e.g., by operating a valve controller, by operating a motor controller for pumps and/or the RCA reactor 630).

Complete mortar removal can be determined by visual inspection or by a method described by Nezhad, et al. (2013) Journal of Testing and Evaluation, 41, DOI: 10.1520/JTE20120026. In this method, RCA samples are soaked and agitated in 2.5-5× volume of 3 M HCl solution, and the mass before and after the reaction is measured. If visible mortar remains after the reaction, the RCA is subjected to further treatment with fresh 3 M HCl solutions. When the mass of the RCA stops changing, the reaction is complete.

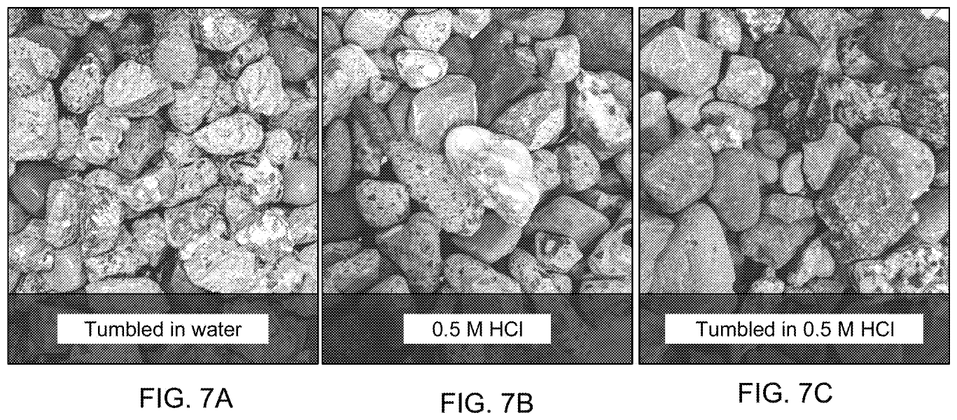

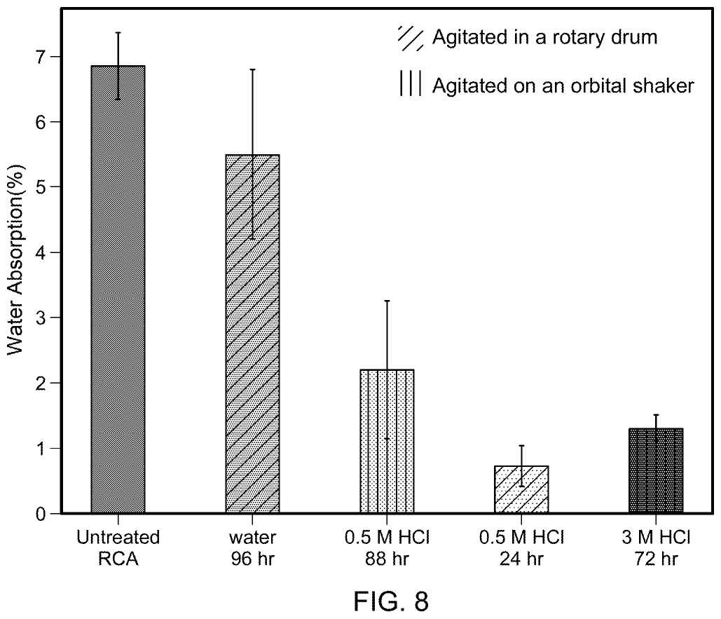

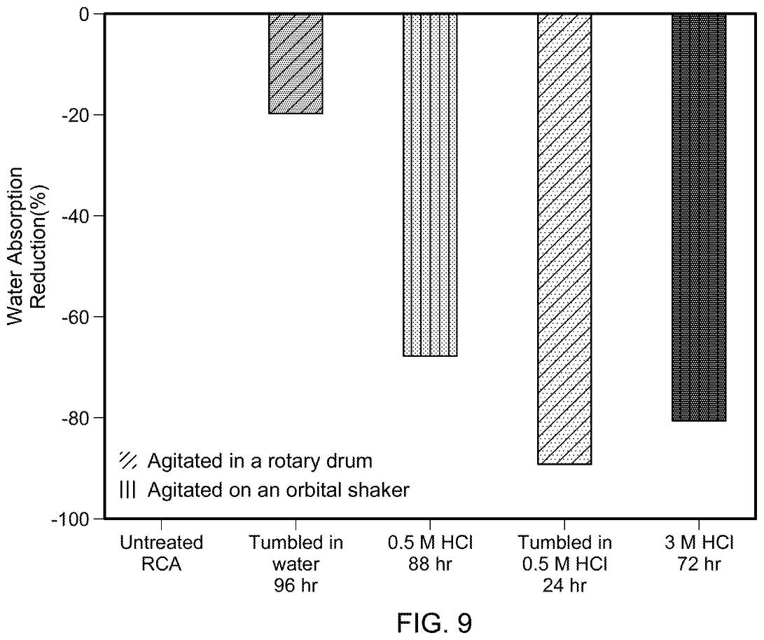

The parameters explored included the presence of acid vs. water, reaction time, RCA loading, and the impact of salt contaminants Recognizing that waste HCl streams from electrochemical OAE typically possess a concentration of ~0.5 M, an initial experiment was conducted utilizing a rotary drum reactor filled with 1 kg of RCA and 6.8 L of 0.5 M HCl. To establish a baseline for comparison, a separate reaction was carried out using 1 kg of RCA and 6.8 L of water under identical conditions. Both drums were rotated at 60 rpm for a duration of 24 hours. While visual inspection revealed substantial mortar detachment from the acid-treated RCA, the control experiment with water exhibited minimal effect. Consequently, the water-treated reaction was extended for an additional 3 days. As shown in FIG. 7A, RCA particles subjected to tumbling in water retained a significant portion of the adhered mortar even after 4 days of agitation. Conversely, the RCA treated with acid displayed near-complete mortar removal (FIGS. 7B and 7C), with a water absorption of 0.7%±0.3%, i.e., an 89.3% decrease compared with the untreated RCA (FIG. 8). In addition, reaction agitation in a rotary drum with entry number 7 from Table 2, where rotary agitation was absent, was compared with RCA exposed to the same 0.5 M HCl solution for a prolonged period of 88 hours. While some degree of mortar removal was observed (FIG. 7B), a substantial amount remained attached, leading to >2% WA. The high WA values obtained for the water-tumbled RCA of 5.5%±1.3% underscore the role of acid in facilitating mortar detachment, whereas the high WA (2.2±1.1%) achieved with the orbital shaker-agitated reaction emphasizes the significance of the rotary reactor's mechanical action in disrupting the mortar matrix containing aluminosilicate gel. These observations collectively demonstrate the requirement for both rotary drum agitation and 0.5 M HCl to achieve the efficient extraction of acceptable aggregates from RCA. In fact, the combination of rotary drum and dilute acid is so effective at removing mortar that the resulting aggregates have a lower WA value than those processed using the ASTM method with large excess of 3 M HCl (FIGS. 8 and 9).

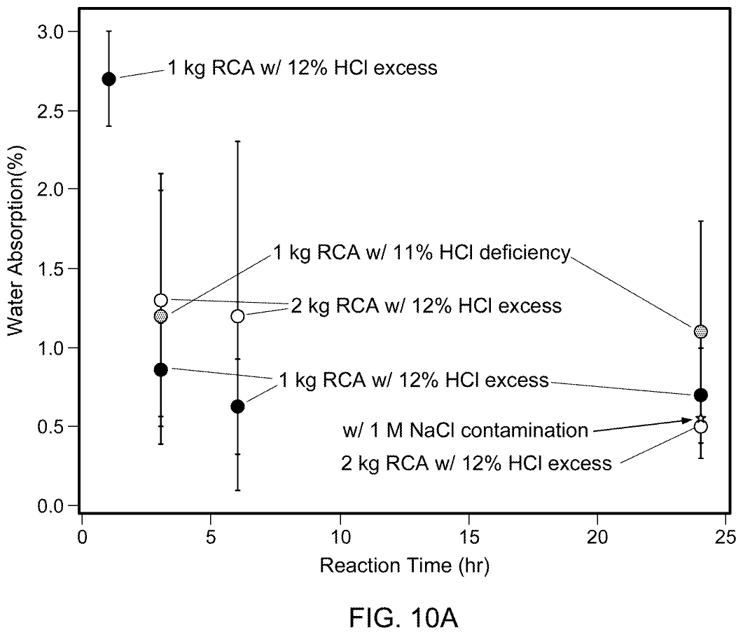

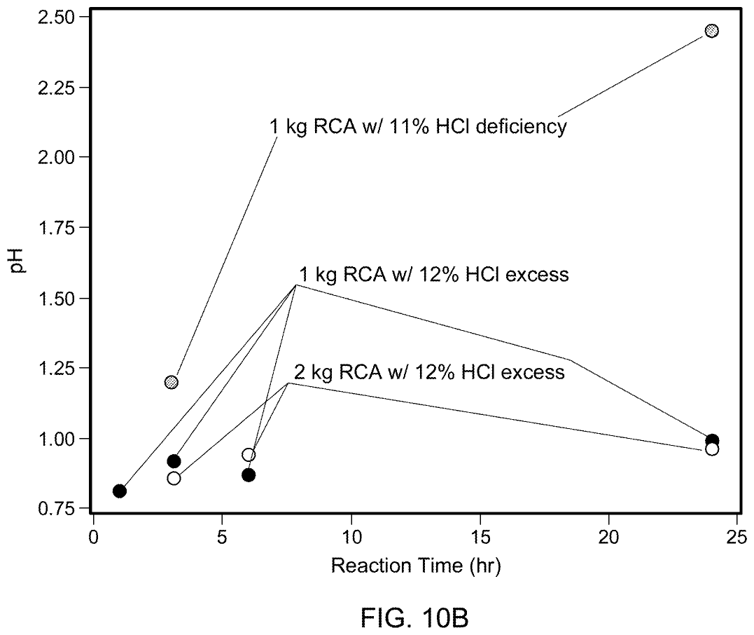

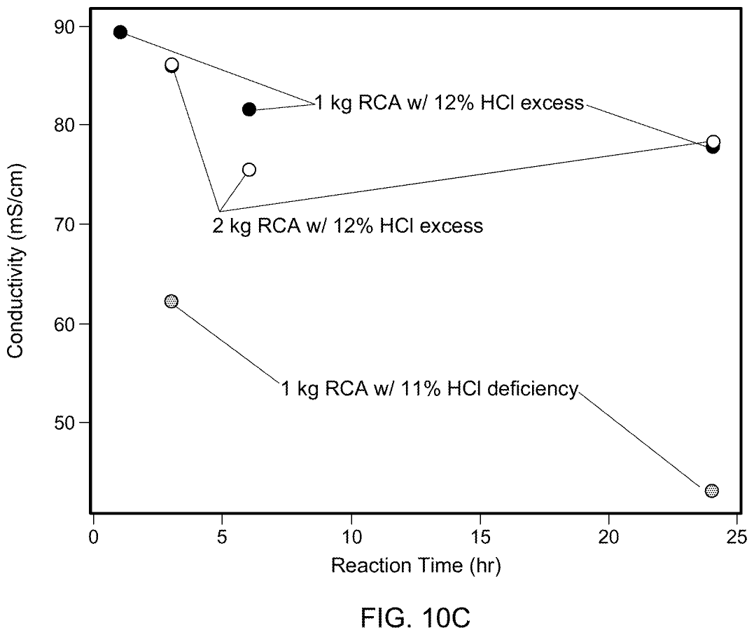

The combined effects of reaction time, acid-to-RCA (AR) ratio, and RCA loading on process efficiency were next investigated, aiming to minimize costs by reducing reaction time, acid usage, and reactor size—all factors influencing CapEx and OpEx. FIGS. 10B, and 10C illustrate the results through comparing the WA of the aggregates and the pH and conductivity of the liquid phase resulting from different reaction conditions. Generally, longer reaction times led to more completed reactions, as indicated by lower WA values and higher pH of the solution except in cases with high AR ratio (12% more than the stoichiometric amount) and low loading (1 kg), where WA reached below 1% even after 3 hours of reaction. The achieved average WA after 6 hr reaction time is even lower than the WA value obtained after 24 hr of reaction time. This comparison suggests that 1 hour is insufficient, while 24 hours is unnecessarily long and wasteful. Reducing the AR ratio closer to the stoichiometric amount of HCl and CaO resulted in higher WA values compared to high AR ratio experiments. Comparing two sets of experiments, one with 12% excess HCl and the other with 11% less HCl than stoichiometric amounts, yielded WA values of 0.7±0.3% and 1.1±0.7%, respectively, after 24 hours of reaction, indicating the importance of driving the reaction toward completion with excess acid. The time-variant experiments at the lower AR ratio showed similar WA values between 3 and 24 hour reaction times, being 1.2±0.8% and 1.1±0.7%, respectively, implying that the reaction is close to completion within 3 hours, consistent with the high AR ratio results. Note that although low AR ratio is less effective in removing the mortar from RCA, it results in a much less acidic final solution after 24 hr of reaction, as indicated by the high pH of 2.5 (FIG. 10B) and lower conductivity of 43.1 mS/cm (FIG. 10C). This will allow easier and less costly post-treatment before discharging the waste salt solution. Increasing the reactor drum loading from 1 kg to 2 kg led to higher WA at 3 and 6 hours, due to reduced agitation efficiency from the increased mass and volume, but a low WA of 0.55% was achieved after 24 hr of reaction. Attempts at 3 kg loading failed as the liquid plus solid volume was too close to drum capacity, which led to leaking when the drum started to rotate. These studies highlight the importance of low loading, which translates to large reactor sizing comparing with the amount of reactants, and high acid content for optimal results; meeting these conditions allows for a shorter 3-hour reaction time, otherwise necessitating longer processing.

### Example 4. Impact of NaCl Content in Acid Source

The use of waste acid sourced from a electrochemical OAE system with seawater input makes NaCl contamination inevitable. To assess the effects of this contamination on reaction outcomes, a reaction was conducted with 2 kg RCA and 0.5 M HCl, in the presence of 1 M NaCl to simulate waste acid conditions. The reaction proceeded without issue, and the resulting aggregates displayed a WA of 0.55% (FIG. 10A). This indicates that salt contamination does not prevent mortar removal by weak acid. Furthermore, acknowledging the concrete industry's concerns about salt content in concrete mixes, the level of salt contamination of the acid+salt treated aggregates was assessed. 250 grams of treated aggregates was soaked in 10 oz of water overnight. The water's conductivity (181 μS/cm) and pH (7.62) were lower than the values (conductivity (257 μS/cm) and pH (8.73)) obtained from a control sample using aggregates from a California quarry. This suggests that NaCl present in the reacting acid does not contribute to significant salt contamination of the aggregates.

### Example 5. Complete Neutralization of Acid and Metal Ion Removal

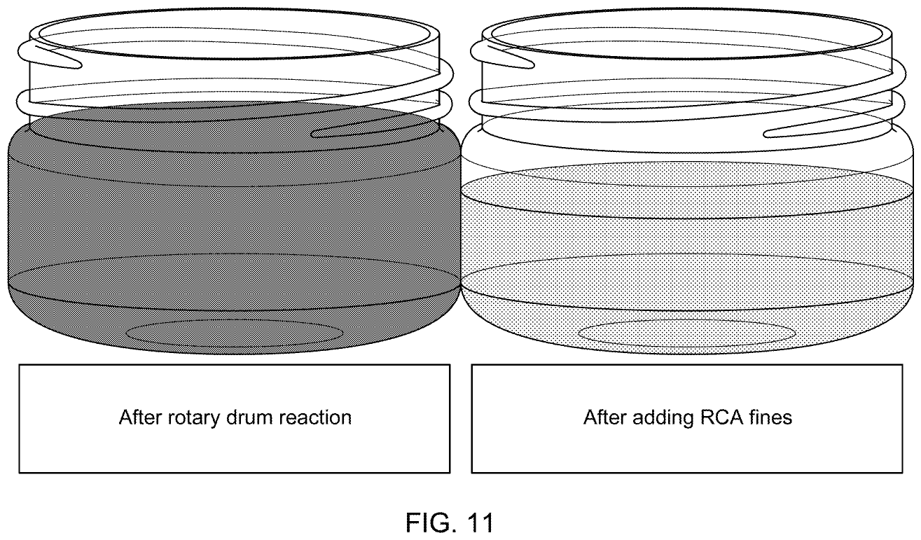

While the reaction between coarse RCA and 0.5 M waste HCl consumes over 80% of the acid, complete neutralization cannot be achieved. This is due to the need for excess acid to ensure thorough mortar removal, as suggested by the results shown in FIGS. 10A, 10B, and 10C. As a result, the solution at the end of the reaction was always mildly acidic. As demonstrated, reducing acid usage lowers solution acidity at the end of reaction but compromises the WA of cleaned aggregates. Direct discharge of the reacted acid (pH 1-3) into the ocean is problematic due to failure to comply with typical acceptable pH ranges of 6 to 9. Furthermore, returning acidity to the ocean would reduce the overall CO₂ removal potential. Therefore, the acid is further neutralized before being returned to the ocean. To address this, the reacted acid was further treated with RCA fines (RCA material passed through a 325 mesh screen). The reacted acid can be treated with the RCA fines in the acid batch tank 632. In an example, 10 grams of these fines were added to 100 mL of reacted acid solution with a pH of 1.45 and conductivity of 57.0 mS/cm. The slurry underwent 30 seconds of stirring followed by vacuum filtration to isolate solids. Strong de-colorization of the solution implied the removal of light-absorbing species by the addition of RCA fines and filtration (FIG. 11). The filtrate exhibited a pH of 6.91 (FIG. 12A) and conductivity of 38.3 mS/cm (FIG. 12B), suggesting successful acid neutralization by the RCA fines. ICP-OES and IC were employed to assess the elemental and ionic composition of liquid samples post-treatment (FIG. 13). Notably, Al, Fe, and Si were below the ICP-OES detection limit (10 mg/L) in the sample treated with RCA fines, confirming the effective removal of these heavy metals. Elevated Ca, Mg, K, and Na concentrations suggest that double replacement reactions of the form: Mₐ(OH)ₓ+M_{b}(Cl)_{y}→Mₐ(Cl)ₓ+M_{b}(OH)_{y} occurred, where Mₐ represents Ca, Mg, K, or Na; M_{b} represents Al or Fe. The stronger basicity and larger solubility of Mₐ hydroxides relative to M_{b} hydroxides drives precipitation of the latter. Additionally, the residual silica is also removed during this lime-softening-like process. Consequently, the waste acid produced from electrochemical OAE, after reaction with coarse RCA in the coarse reactor 626 and with fine RCA in the acid batch tank 632, is devoid of toxic heavy metals or silica and contains only species commonly found in seawater. Neutralization can also be achieved with coarser RCA fines. The addition of 10, 50, and 100 grams of RCA fines passing a #50 mesh (297 microns) to three 100 mL volumes of reacted acid resulted in a pH increase to 3.0, 5.2, and 5.8 within 30 seconds of stirring, respectively. After 24 hours of immersion without stirring, the pH further increased to 3.8, 6.2, and 6.9, respectively. Despite the smaller increase in pH compared to finer particles, 97% of the acidity is neutralized using the same mass of coarser fines. This reduced pH change suggests lower reactivity of the coarser fines, likely due to decreased specific surface area and slower mass transport. Further optimization of reaction time and agitation is necessary when using different types of RCA fines.

### Example 6. Determination of CO₂ Absorbed in Aged RCA

It is known that concrete absorbs CO₂ from the air, and one study estimated concrete carbonates at a rate of 4.08 mm/yr. This means that a concrete wall may experience 4.08 mm of carbonation after one year, 5.77 mm after two years, and 12.90 mm after ten years. Given the chemical similarity between concrete waste and concrete, it can be hypothesized this carbonation rate applies to concrete waste as well. Typical concrete core walls have a minimum thickness of 4 inches (101.6 mm), which significantly delays the carbonation process over time. In contrast, crushed concrete waste or RCA typically consists of much smaller particles, ranging from 2 inches down to microns in diameter. Without wishing to be bound by theory, this increased surface area exposed to atmospheric CO₂ may result in faster rate of carbonation. Consequently, when such wastes are treated with acid, the carbonates react and release CO₂. This CO₂ is ideally measured and accounted for as it is subtracted from any negative emissions claimed. However, even if the waste concrete input is completely carbonated, there are significant advantages to liberating the stored CO₂ in CaCO₃ and subsequently storing it as NaHCO₃ in ocean. This is attributed to the stoichiometry of the reactions involved. Each molecule of CaCO₃ can neutralize two molecules of HCl while releasing one molecule of CO₂. Simultaneously, the electrolytic process or electrodialysis co-generates two molecules of NaOH, each capable of sequestering two CO₂ molecules as bicarbonate. Under practical oceanic conditions, each NaOH molecule is estimated to capture approximately 0.8 CO₂ molecules. Consequently, the overall process liberates one CO₂ molecule while sequestering 1.6, rendering it 60% more efficient than storing CO₂ solely as CaCO₃. In the current example, the extent of pre-carbonation within the concrete waste samples was quantified.

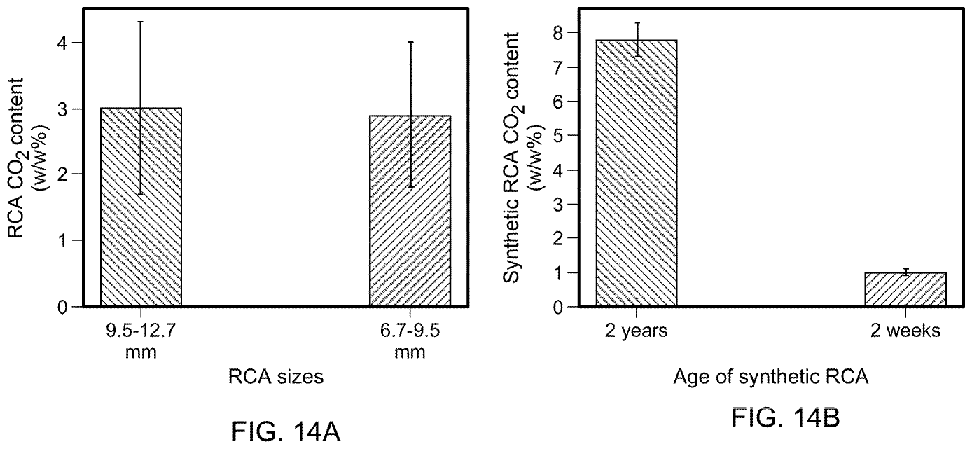

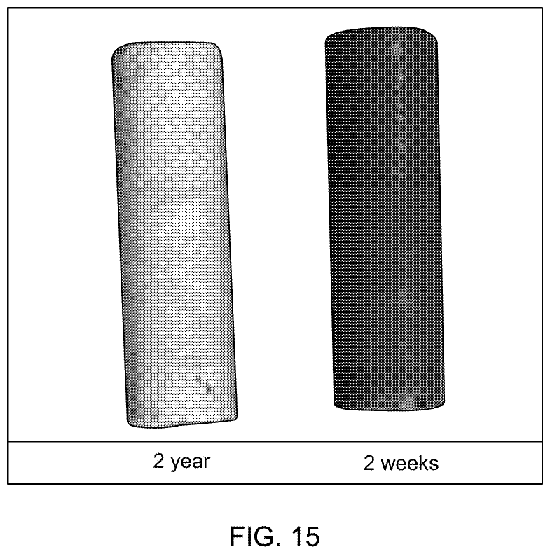

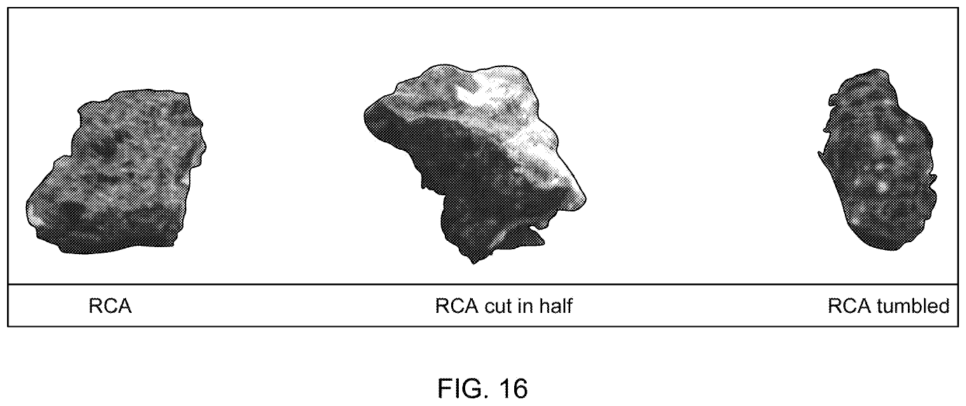

Instrumental gas analysis (IGA) on RCA of two sizes, i.e., 9.5-12.7 mm and 6.7-9.5 mm in diameter, revealed that evolved CO₂, attributed to the decomposition of solid carbonates, constituted 3.1±1.3% and 3.2±1.3% of the total RCA mass (FIG. 14A) for the two size groups, respectively. Assuming all carbonates are CaCO₃, it was estimated that 3.8% of the RCA mass was carbonated CaO, with the remaining 4.7% being uncarbonated CaO, resulting in a carbonation degree of 44.7% for these RCA. This significant level of carbonation would offset the effect of the OAE process unless it is captured. However, utilizing freshly demolished concrete with minimal storage or delays, could potentially avoid this issue. To confirm the hypothesis, synthetic RCA samples were prepared and evaluated for CO₂ content after storing for different amount of time. To have better controls over the sample geometry and simulated the effect of storage time on RCA carbonation, mortar cylinders were prepared, composed of 3:1:0.5 sand, Type I cement and water, as synthetic RCA. The size of these cement mortars was 3.0 cm in height and 0.9 cm in diameter. The carbon content of these synthetic samples was evaluated by IGA after storing them in air for two years and two weeks, respectively. The IGA results are shown in FIG. 14B, which indicates a significantly lower CO₂ content in the two-week old samples. A phenolphthalein test also clearly distinguished the two-week old sample, which was rich in alkaline content, from the colorless two-year old sample (FIG. 15). This comparison indicated that utilizing freshly demolished concrete, leftover cement directly from trucks, or any waste alkaline species with minimal storage time, can significantly mitigate the issue of CO₂ re-emission. If fresh waste material is unavailable, older, carbonated samples can still be utilized after the carbonated outer layer is mechanically removed. FIG. 16 illustrates the results of a phenolphthalein test on three RCA samples. While the surface of the RCA was fully carbonated, the inner core retained much more alkalinity, as shown by pink color on the cut face (FIG. 16, center). The sample on the right, after four days of tumbling in water in the rotary drum, had its original surface mechanically removed, revealing a new surface that turned pink upon contact with phenolphthalein. This demonstrates that mechanical surface removal can serve as a pre-treatment for RCA before reacting it with acid to reduce CO₂ emissions. The material that was scrapped off from RCA surface may be used as filler materials in applications. A mature and steady-state version of the method can offer a symbiotic relationship between the construction/demolition and OAE industries, reducing waste disposal cost, associated with both storage and landfill, for the former and preventing the accumulation of hazardous acid waste on-site or costly disposal for the latter.

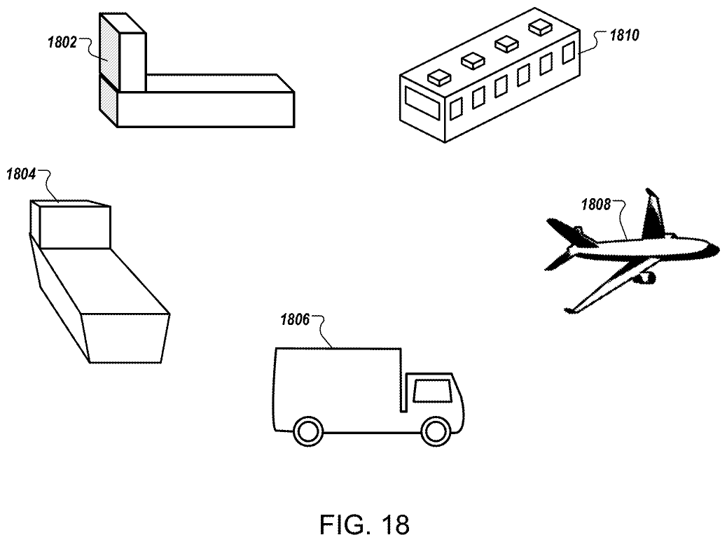

FIG. 18 shows example platforms for mobile processing plants. A platform for a mobile processing plant can be, for example, a barge 1802, a ship 1804, a truck 1806, an aircraft 1808, or a railroad car 1810. A platform for an electrolyzer should have access to seawater. A platform for an RCA reactor system should be large enough to contain and process RCA.

In some examples, the mobile processing plant can include an electrolyzer and an RCA reactor that are supported by a single platform. For example, a marine vessel such as the barge 1802 or the ship 1804 may have access to seawater for use by the electrolyzer and may be large enough to support RCA processing. Therefore, a mobile processing plant can include an electrolyzer and an RCA reactor supported by a single marine vessel. In some examples, the mobile processing plant can include an electrolyzer supported by a first platform and an RCA reactor supported by a second platform. For example, the electrolyzer may be supported by the ship 1802, and the RCA reactor system may be supported by a truck 1806. Acidified brine generated by the electrolyzer on the ship 1802 can be transported to the RCA reactor system supported by the truck in order to process collected RCA.

1. A method of increasing the pH of a body of saline water comprising:
(a) contacting saline water obtained from the body of saline water with an electrolyzer to obtain a liquid rich in one or more metal hydroxide and a liquid rich in HCl;
(b) contacting the body of saline water with the liquid rich in one or more metal hydroxide of step (a);
(c) contacting inorganic waste with the liquid rich in HCl of step (a) to form recovered concrete aggregates and a liquid rich in inorganic salts; and
(d) optionally repeating steps (a)-(c).

2. The method of claim 1, further comprising separating the recovered concrete aggregates from the liquid rich in inorganic salts of step (c).

3. The method of claim 1, wherein step (a)-(c) are repeated using the same batch of inorganic waste.

4. The method of claim 1, wherein contacting the inorganic waste with the liquid rich in HCl of step (c) occurs in a tumbler.

5. The method of claim 4, wherein the tumbler comprises a rotating drum reactor.

6. The method of claim 1, wherein the recovered concrete aggregates have a water absorption of about 1% to about 2%.

7. The method of claim 1, wherein each of the steps of the method are repeated continuously.

8. The method of claim 1, wherein the electrolyzer comprises a membrane electrodialysis (MED) cell.

9. The method of claim 1, wherein the electrolyzer comprises a bipolar electrodialysis (BPMED) cell.

10. The method of claim 1, wherein the inorganic waste comprises recycled concrete aggregates (RCA).

11. The method of claim 1, wherein the inorganic waste comprises incinerator bottom ash aggregates (IBAA).

12. The method of claim 1, wherein the inorganic waste comprises a mixture of RCA and IBAA.

13. The method of claim 1, wherein the one or more metal hydroxide is comprised of alkali metal hydroxide, alkali earth metal hydroxide, or a combination thereof.

14. The method of claim 1, wherein the one or more metal hydroxide is comprised of alkali metal hydroxide.

15. The method of claim 1, wherein the one or more metal hydroxide is comprised of alkali earth metal hydroxide.

16. The method of claim 1, further comprising removing CO₂ from the liquid rich in HCl of step (a) prior to contacting the inorganic waste with the liquid rich in HCl.

17. The method of claim 1, further comprising removing CO₂ evolved during treatment of the inorganic waste with HCl from the liquid rich in inorganic salts of step (c).

18. The method of claim 1, further comprising tumbling the inorganic waste in water prior to contacting with the liquid rich in HCl in step (c).

19. The method of claim 1, further comprising contacting the liquid rich in inorganic salts of step (c) with RCA fines.

20. The method of claim 1, further comprising contacting the body of saline water with the liquid rich in inorganic salts.

21. A system configured to perform the method of claim 1.

22. The system of claim 21, wherein the electrolyzer comprises cathode materials selected from the group consisting of C, Ni—Al Raney nickel alloys, low carbon steel, and Ni-, Pt-, Pd-, Ag-, Au-, Zn-, Fe-, Ru-, Ir-, Mo- or Cd-based alloys or compounds.

23. The system of claim 21, wherein the electrolyzer comprises anode materials selected from the group consisting of platinum, dimensionally stable anodes, ruthenium-iridium-titanium mixtures, and mixtures of C, Ti, Zr, Hf, Nb, Ta, W, Al, Bi, Pt, Ir, Rh, Ru, Os, Pd, Cu, Ag, Au, Fe, Co, Ni, Sn, Si, Pb, Sb, As, Cr, and Mn.

24. The method of claim 1, wherein the body of saline water is selected from the group consisting of an ocean, a sea, a canal, a reservoir, a lake, and a river.

25. The method of claim 1, wherein the saline water obtained from the body of saline water is brine.

26. The method of claim 25, wherein the brine is from desalination of water obtained from the body of saline water.

27. The method of claim 1, wherein inorganic waste comprises adsorbed CO₂.

28. The method of system of claim 1, wherein the liquid rich in HCl of step (a) comprises NaCl.

29-39. (canceled)
